(19) United States
(12) Patent Application Publication
(10) Pub. No.: US 2024/0223686 A1
(43) Pub. Date: Jul. 4, 2024

(54) ELECTRONIC DEVICE AND METHOD FOR CONTROLLING DRIVING OF MOTOR

(71) Applicant: Samsung Electronics Co., Ltd., Suwon-si (KR)

(72) Inventors: Raetae KIM, Suwon-si (KR); Moonjeong KIM, Suwon-si (KR); Myunghoon KWAK, Suwon-si (KR); Jookwan LEE, Suwon-si (KR); Duyeong CHOI, Suwon-si (KR); Yangwook KIM, Suwon-si (KR); Junghyeob LEE, Suwon-si (KR); Changryong HEO, Suwon-si (KR)

(21) Appl. No.: 18/609,513

(22) Filed: Mar. 19, 2024

Related U.S. Application Data
(63) Continuation of application No. PCT/KR2022/011108, filed on Jul. 28, 2022.

(30) Foreign Application Priority Data
Sep. 27, 2021 (KR) 10-2021-0127184

(51) Int. Cl. H04M 1/02

(52) U.S. Cl. CPC H04M 1/0235; H04M 1/0268; H04M 2201/38

(57) ABSTRACT

According to various embodiments, an electronic device may comprise: a motor; a flexible display having an externally visible screen area configured to be extended or shrunk by driving the motor; a driving level determination unit comprising circuitry configured to determine a driving level for the motor based on one or more pieces of context information related to the electronic device based on the screen area being requested to be extended or shrunk; and a driving control unit comprising circuitry configured to drive the motor according to the determined driving level.

### CROSS-REFERENCE TO RELATED APPLICATIONS

This application is a continuation of International Application No. PCT/KR2022/011108 designating the United States, filed on Jul. 28, 2022, in the Korean Intellectual Property Receiving Office and claiming priority to Korean Patent Application No. 10-2021-0127184, filed on Sep. 27, 2021, in the Korean Intellectual Property Office, the disclosures of each of which are incorporated by reference herein in their entireties.

### BACKGROUND

### Field

Various embodiments of the disclosure relate to an electronic device and a method for controlling the same, for example, an electronic device having a motor whose driving is controlled based on a relevant context and a method for controlling motor driving.

### Description of Related Art

More and more attention is being given to electronic devices with a flexible display configured to provide a larger screen as necessary while providing high portability. In particular, there is a growing interest in electronic devices having a rollable display of which a portion is rolled into the housing of the electronic device to maintain a small size and, when required, is rolled out to provide a larger size screen to the user.

The rollable display may be manipulated so that a portion of the externally visible screen area is shrunk, e.g., rolled into the housing of the electronic device, or the rolled-in portion is extended, e.g., visible, to the outside of the housing through driving of a motor coupled thereto. However, driving of the motor may cause noise which may increase in proportion to the driving speed of the motor. Noise generated by driving the motor may cause discomfort to the user and may disturb the user's experience of using other functions of the electronic device (e.g., the experience of using certain applications on a smartphone). Meanwhile, when the screen area of the rollable display provided in the electronic device extends or contracts, the user's grip may become unstable depending on the position of the user's hand holding the electronic device. Disturbance of the use experience or unstable grip issue by noise may be slightly mitigated by decreasing the driving speed of the motor. However, this method slows down the operation of the device, resultantly degrading user experience in another way.

### SUMMARY

Embodiments of the disclosure provide an electronic device and a motor driving method configured to drive a motor at a driving level variable determined based on various pieces of context information about the electronic device to provide an improved user experience considering the noise caused by motor driving, unstable user grip issues, and quick device operation in relation to an electronic device having a flexible display having a variable screen area visible to the outside by driving a motor.

Embodiments of the disclosure provide an electronic device configured to provide graphic affordance to allow the user to properly deal with the extension or shrinkage of a screen area or partially restrict the extension or shrinkage of the screen so as to mitigate the unstable user grip issues caused due to the extension or shrinkage of the screen area in relation to an electronic device having a flexible display with an externally visible screen area extended or shrunk by motor driving.

According to various example embodiments, an electronic device may comprise: a motor, a flexible display having an externally visible screen area configured to be extended or shrunk by driving the motor, a driving level determination unit comprising circuitry configured to determine a driving level for the motor based on one or more pieces of context information related to the electronic device based on the screen area being requested to be extended or shrunk, and a driving controller comprising circuitry configured to drive the motor according to the determined driving level.

According to various example embodiments, a method for controlling driving of a motor in an electronic device having a flexible display having an externally visible screen area extended or shrunk by driving the motor may comprise: obtaining a request for triggering to drive the motor, obtaining one or more pieces of context information related to the electronic device, for each of the one or more pieces of context information, determining according to a priority whether the respective piece of the context information meets a condition and, based on the condition being determined to be met, adjust a driving level of the motor according to a given criterion, determining a result of the adjustment as the driving level of the motor, and driving the motor according to the determined driving level.

An electronic device according to various example embodiments of the disclosure may provide an improved user experience and user convenience considering the noise caused by motor driving, unstable grip issues, and demand for quick device operation by variably determining a motor driving level according to the context regarding the electronic device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1A and 1B include a diagram and a cross-sectional view illustrating a structure of an electronic device in a slide-in state according to various embodiments;

FIGS. 2A and 2B include a diagram and a cross-sectional view illustrating a structure of an electronic device in a slide-out state according to various embodiments;

FIG. 3 is a block diagram illustrating an example electronic device in a network environment according to various embodiments;

FIG. 4 is a block diagram illustrating an example configuration of an electronic device according to various embodiments;

FIGS. 5A, 5B, 5C, 5D and 5E are graphs illustrating various motor driving levels for the electronic device of FIG. 4, in a plurality of sequential steps, according to various embodiments;

FIG. 6 is a table illustrating categories of example context information that may be used to adjust the driving level of a motor by the driving level determination unit of FIG. 4 and example conditions and the respective corresponding adjustment ranges for adjusting each motor driving level for each context category, according to various embodiments;

FIG. 7 is a flowchart illustrating example operations of an example procedure for determining a driving level of a motor by the driving level determination unit of FIG. 4 according to various embodiments;

FIG. 8 is a diagram illustrating various examples of adjusting a driving level of a motor based on various context categories shown in FIG. 6 and the motor driving level classification shown in FIG. 5, according to various embodiments;

FIGS. 9A, 9B, 9C and 9D are diagrams illustrating various contexts in which an externally visible screen area is extended or shrunk as a portion of a flexible display is slid in or out of a housing according to various embodiments;

FIG. 10 is a chart illustrating example criteria of adjusting a driving level for each condition considering an extended/shrunk position and grip position context according to various embodiments;

FIGS. 11A and 11B are graphs illustrating an example of modifying a pattern of a driving level selected for a motor to enhance grip stability when extending or shrinking a screen area of a flexible display according to various embodiments;

FIGS. 12A and 12B are diagrams illustrating a modified example of restricting extension of a screen area of a flexible display to a predetermined range to enhance grip stability when extending the screen area of the flexible display according to various embodiments;

FIGS. 13A, 13B, 13C, 13D, 13E and 13F are diagrams illustrating examples of various graphic indicators or graphic affordances that may be displayed on a flexible display to enhance grip stability when extending or shrinking a screen area of the flexible display according to various embodiments;

FIG. 14 is a chart illustrating various examples of methods and criteria for adjusting a driving level for a motor based on ambient noise context by a driving level determination unit under the motor driving level shown in FIG. 5 according to various embodiments;

FIG. 15 is a diagram illustrating various examples of adjusting a driving level of a motor based on a driving level adjustment condition of ambient noise context and corresponding adjustment range according to (a) of FIG. 14 and considering the mode setting context and/or ringtone setting context shown in FIG. 6 under the motor driving level shown in FIG. 5 according to various embodiments;

FIG. 16 is a chart illustrating various examples of methods and criteria for adjusting a driving level for a motor based on volume setting context by a driving level determination unit under the motor driving level shown in FIG. 5 according to various embodiments;

FIGS. 17A, 17B, 17C and 17D are diagrams illustrating relationships between various volume setting states and driving level adjustment ranges in relation to an embodiment of dynamically adjusting a driving level of a motor by a user in an adjustment range determined based on a volume setting state according to FIG. 16 according to various embodiments;

FIG. 18 is a diagram illustrating an example volume control bar that may be displayed on a screen of a display when a volume setting state and a motor driving level are adjusted in conjunction with each other through manipulation of a volume control bar according to various embodiments;

FIGS. 19A and 19B are diagrams illustrating visual indicators provided to intuitively recognize a position where a screen is extended or shrunk and a current motor driving level in relation to the extension or shrinkage of the screen of a flexible display according to various embodiments; and

FIGS. 20A and 20B are diagrams illustrates display of setting options to allow a user to select whether to use a function of adjusting a driving level of a motor based on one or more contexts according to various embodiments.

### DETAILED DESCRIPTION

Hereinafter, various example embodiments of the disclosure are described in greater detail with reference to the accompanying drawings. In the following description, specific details, such as detailed configurations and components, are provided merely for a better understanding of the various example embodiments of the disclosure. Accordingly, it should be apparent to one of ordinary skill in the art that various changes and modifications may be made to the various example embodiments described herein without departing from the scope and spirit of the disclosure. Further, description of well-known functions and configurations may be omitted for clarity and brevity.

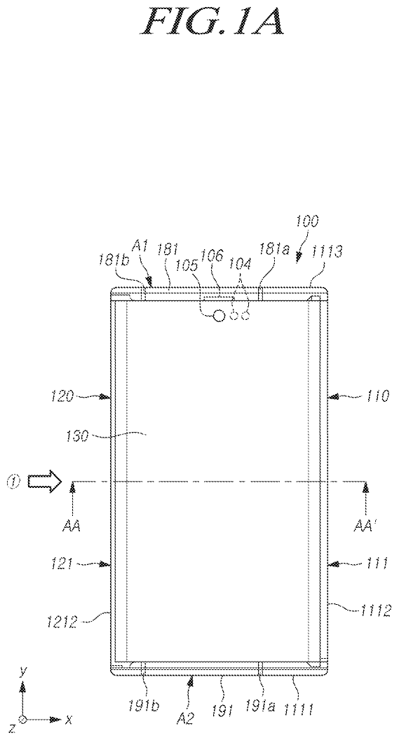

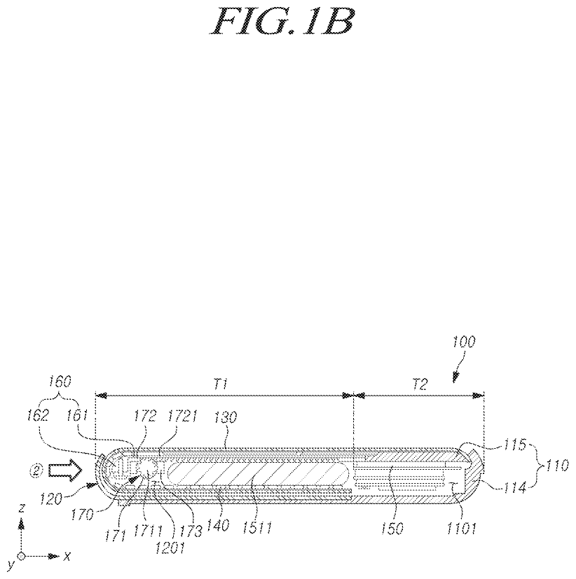

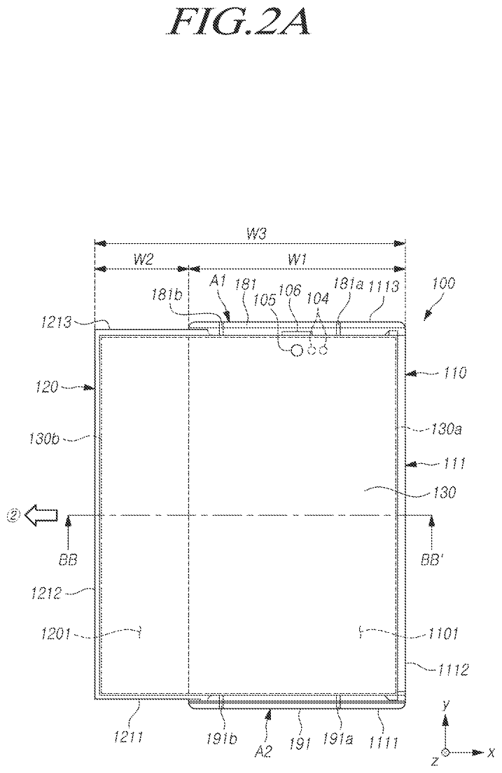

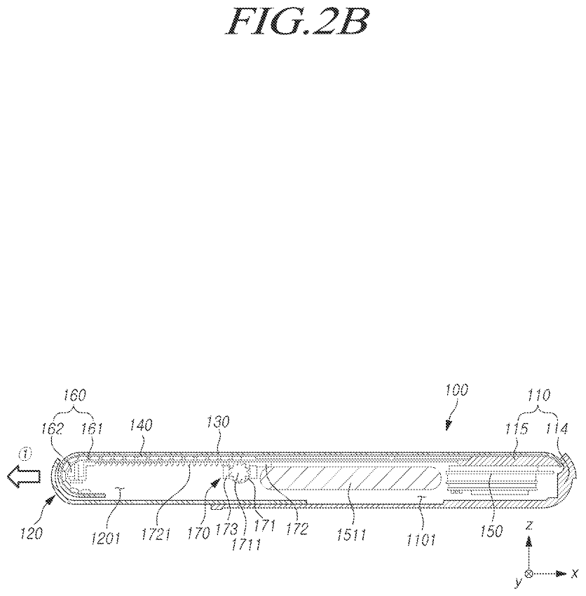

FIGS. 1A and 1B include a diagram and cross-sectional view illustrating an example structure of an electronic device in a slide-in state according to various embodiments. For example FIG. 1A is a front view of an electronic device in a slide-in state according to various, and FIG. 1B is a cross-sectional view taken along line AA-AA′ of FIG. 1A. FIGS. 2A and 2B include a diagram and cross-sectional view illustrating an example structure of an electronic device in a slide-out state according to various embodiments. For example, FIG. 2A is a front view of an electronic device in a slide-out state according to various embodiments, and FIG. 2B is a cross-sectional view taken along line BB-BB′ of FIG. 2A according to various embodiments.

Referring to FIGS. 1A, 1B, 2A and 2B, an electronic device 100 may include a first housing 110 (e.g., a base housing), a second housing 120 (e.g., a slide housing) movably coupled to the first housing 110 within a designated distance in a designated direction (e.g., x-axis direction), and a flexible display 130 (e.g., expandable display or stretchable display) disposed to be supported through at least a portion of the first housing 110 and the second housing 120. According to an embodiment of the disclosure, at least a portion of the second housing 120 may switch to the slide-in state by being received in a first space 1101 of the first housing 110. According to an embodiment of the disclosure, the electronic device 100 may include a bendable member (or bendable support member) 140 (e.g., articulated hinge module or multi-bar assembly) that is at least partially coplanar with at least a portion of the first housing 110 in the slide-in state and, in the slide-out state, is at least partially received in a second space 1201 of the second housing 120. According to an embodiment, at least a portion of the flexible display 130 may be disposed not to be viewed from the outside by being received in the inner space 1201 of the second housing 120 while being supported by the bendable member 140 in the slide-in state. According to an embodiment, at least a portion of the flexible display 130 may be disposed to be visible to the outside while being supported by the bendable member 140 at least partially coplanar with the first housing 110 in the slide-out state.

According to an embodiment of the disclosure, the first housing 110 may include a first side member 111, and the second housing 120 may include a second side member 121. According to an embodiment, the first side member 111 may include a first side surface 1111 having a first length along a first direction (e.g., the x-axis direction), a second side surface 1112 extending to have a second length larger than the first length along a direction (e.g., the y-axis direction) substantially perpendicular to the first side surface 1111, and a third side surface 1113 extending from the second side surface 1112 and having the first length, disposed substantially parallel to the first side surface 1111. According to an embodiment, the first side member 111 may be at least partially formed of a conductive material (e.g., metal).

According to various embodiments of the disclosure, the second side member 121 may include a fourth side surface 1211 at least partially corresponding to the first side surface 1111 and having a third length, a fifth side surface 1212 extending from the fourth side surface 1211, disposed substantially parallel to the second side surface 1112, and having a fourth length larger than the third length, and a sixth side surface 1213 extending from the fifth side surface 1212, disposed to correspond to the third side surface 1113, and having the third length. According to an embodiment, the second side member 121 may be at least partially formed of a conductive material (e.g., metal).

According to an embodiment, the first side surface 1111 and the fourth side surface 1211 may be slidably coupled to each other, and the third side surface 1113 and the sixth side surface 1213 may be slidably coupled to each other. According to an embodiment, in the slide-in state, the fourth side surface 1211 may be disposed to be substantially invisible from the outside by overlapping the first side surface 1111. According to an embodiment, in the slide-in state, the sixth side surface 1213 may be disposed to be substantially invisible from the outside by overlapping the third side surface 1113.

According to various embodiments of the disclosure, the electronic device 100 may include a flexible display 130 disposed to be supported by at least a portion of the first housing 110 and the second housing 120. According to an embodiment, the flexible display 130 may include a first portion 130a (e.g., a flat portion) that is always visible to the outside and a second portion 130b (e.g., a bendable portion) that extends from the first portion 130a and is received in a second space 1201 of the second housing 120 so as not to be at least partially visible to the outside in the slide-in state. According to an embodiment, the first portion 130a may be disposed to be supported by the first housing 110, and the second portion 130b may be disposed to be at least partially supported by the bendable member 140. According to an embodiment, the flexible display 130 may extend from the first portion 130a while being supported by the bendable member 140, may form substantially the same plane as the first portion 130a, and may be disposed to be visible to the outside in a state in which the second housing 120 is slid out in a designated direction (direction \textcircled{2}). According to an embodiment, the second portion 130b of the flexible display 130 may be received in the second space 1201 of the second housing 120 and may be disposed not to be visible to the outside in a state in which the second housing 120 is slid in a designated direction (direction \textcircled{1}). Accordingly, in the electronic device 100, as the second housing 120 moves from the first housing 110 in a sliding manner along a designated direction (e.g., the x-axis direction), the screen size visible to the outside of the flexible display 130 may be variably increased or reduced.

According to various embodiments of the disclosure, the first housing 110 and the second housing 120 may slide relative to each other so that the width of the electronic device 100 changes. According to an embodiment, the electronic device 100 may be configured to have a first width W1 from the second side surface 1112 to the fourth side surface 1212 in the slide-in state. According to an embodiment, at least a portion of the bendable member 140 received in the second space 1201 of the second housing 120 may be moved to provide an additional second width W2 in the slide-out state, and thus the electronic device 100 may be configured to have a third width W3 larger than the first width W1. For example, the flexible display 130 may have a screen size substantially corresponding to the first width W1 in the slide-in state, and may have an extended screen size substantially corresponding to the third width W3 in the slide-out state.

According to various embodiments, the electronic device 100 may include at least one of an input device (e.g., a microphone not shown in the drawings) disposed in the first space 1101 of the first housing 110, a sound output device (e.g., a call receiver 106 or a speaker (not shown in the drawings)), a sensor module 104, or a camera module 105. According to other embodiments, the electronic device 100 may be configured so that at least one of the above-described components is omitted or other components are additionally included. According to other embodiments, at least one of the above-described components may be disposed in the second space 1201 of the second housing 120.

According to various embodiments of the disclosure, the electronic device 100 may provide various types of functions using a microphone and/or a call receiver 106 or a speaker. For example, the electronic device 100 may provide a phone call function and a video call function using the microphone and the call receiver 106. For example, the electronic device 100 may provide a voice recording function using a microphone, and may provide a music playback function using only a speaker without a microphone.

According to various embodiments of the disclosure, the sensor module 104 may generate an electrical signal or a data value corresponding to an internal operating state of the electronic device 100 or an external environmental state. The sensor module 104 may include, e.g., a proximity sensor, an illuminance sensor, and a noise measurement sensor disposed on the front surface of the electronic device 100, but the disclosure is not limited thereto. According to an embodiment, the sensor module 104 may include, on the front surface of the electronic device 100, a touch screen sensor disposed on the display panel of the flexible display 130 or a touch detection sensor disposed on the side surface of the electronic device 100, but the disclosure is not limited thereto. According to an embodiment, the electronic device 100 may detect the position of the user's grip on the electronic device 100 through the touch screen sensor and/or the touch detection sensor of the sensor module 104. According to an embodiment, the sensor module 104 may include at least one of a proximity sensor, an illuminance sensor, a noise measurement sensor, a time of flight (TOF) sensor, an ultrasonic sensor, a fingerprint recognition sensor, a gesture sensor, a gyro sensor, an atmospheric pressure sensor, a magnetic sensor, an acceleration sensor, a grip detection sensor, a color sensor, an infrared (IR) sensor, a biometric sensor, a temperature sensor, or a humidity sensor. In the drawings, only the sensor module 104 disposed on the front surface of the electronic device 100 is illustrated, but the disclosure is not limited thereto. The electronic device 100 may further include other various sensor modules disposed on the front surface or the rear surface.

According to various embodiments of the disclosure, the camera module 105 may include one or more lenses, an image sensor, and/or an image signal processor. According to an embodiment, the camera module 105 may be disposed under the flexible display 130 and may be configured to photograph a subject through a portion of an active area of the flexible display 130.

According to various embodiments of the disclosure, the camera module 105 and/or the sensor module 104 may be disposed to detect an external environment through the flexible display 130. According to various embodiments, the electronic device 100 may detect the strength and/or illuminance of ambient noise through the sensor module 104. For example, the camera module 105 or the sensor module 104 may be disposed in the first space 1101 of the first housing 110 to contact an external environment through a transmissive area or a perforated opening formed in the flexible display 130.

According to various embodiments of the disclosure, the electronic device 100 may include at least one antenna A1 and A2 electrically connected to a wireless communication circuit (not shown) disposed in the first space 1101 of the first housing 110. According to an embodiment, the at least one antenna A1 and A2 may include a first antenna A1 disposed in an upper area and a second antenna A2 disposed in a lower area of the electronic device 100. In an embodiment, the electronic device may further include at least one additional antenna disposed on the second side surface 1112 of the first housing 110 and/or the fifth side surface 1212 of the second housing 120. According to an embodiment, the first antenna A1 may include a first conductive portion 181 segmented through at least one non-conductive portion 181a and 181b on the third side surface 1113 of the first side member 111 and electrically connected to a wireless communication circuit (not shown) of the electronic device 100. According to an embodiment, the second antenna A2 may include a second conductive portion 191 segmented through at least one non-conductive portion 191a and 191b on the first side surface 1111 of the first side member 111 and electrically connected to a wireless communication circuit (not shown) of the electronic device 100.

According to various embodiments of the disclosure, the slide-in/slide-out operation of the electronic device 100 may be performed by motor driving. According to various embodiments, the electronic device 100 may include a driving module 170 disposed in an inner space (e.g., the first space 1101 and the second space 1201) for the slide-in/slide-out operation and providing a driving force for moving the second housing 120 from the first housing 110 in the slide-out direction (direction (2) in which the externally visible screen is extended) and/or the slide-in direction (direction (1) in which the externally visible screen is shrunk). According to various embodiments, upon detecting a trigger event for switching from the slide-in state to the slide-out state or from the slide-out state to the slide-in state, the electronic device 100 may drive the motor 171 of the driving module 170 according to a motor driving level (a predetermined time-speed function) determined by the driving level determination unit (not shown in FIGS. 1 and 2). According to an embodiment of the disclosure, the trigger event may occur through a touch operation on a certain operation button (not shown) disposed on the electronic device 100 and/or a certain object displayed on the flexible display 130. According to an embodiment, the motor 171 and the gear structure 172 of the driving module 170 may be provided in units of modules, and may include a friction reduction structure for reducing frictional force, thereby helping to enhance operational reliability of the electronic device 100.

According to an embodiment, the first space 1101 of the first housing 110 may be provided through coupling of the cover housing 114 and the bracket housing 115. According to an embodiment, the electronic device 100 may include a substrate 150 disposed in the first space 1201 between the cover housing 114 and the bracket housing 115 and at least one battery 1511 disposed near the substrate 150. According to an embodiment, the bendable member 140 may be disposed so that one end thereof is fixed to the first housing 110 and the other end thereof is at least partially movably received in the second space 1201 of the second housing 120. For example, the bendable member 140 may be at least partially received in the second space 1201 in the slide-in state, and may be at least partially slid out from the second space 1201 to form substantially the same plane as the first housing 110 (e.g., the bracket housing 115) in the slide-out state. Accordingly, the flexible display 130 supported by at least a portion of the first housing 110 and the bendable member 140 may be varied as the size of the externally visible screen is increased or reduced according to the sliding operation. According to an embodiment, the electronic device 100 may include at least one guide rail (not shown) disposed between the first housing 110 and the second housing 120 to lead to a sliding operation of the second housing 120.

According to various embodiments of the disclosure, the electronic device 100 may include a sliding frame 160 disposed to be at least partially movable from the first housing 110 in the direction (direction \textcircled{2}) of the second space 1201 and coupled to the second housing 120. According to an embodiment, the sliding frame 160 may include a plate portion 161 slidably coupled to the first housing 110 (e.g., the bracket housing 115) and a sliding bar 162 extending from the plate portion 161 and pressing the rear surface of the bendable member 140. According to an embodiment, the sliding frame 160 may be integrally formed with the second housing 120.

According to an embodiment, the driving module 170 may include a motor 171 including a first gear 1711 (e.g., a pinion gear) disposed in the first housing 110 (e.g., the bracket housing 115), and a gear structure 172 including a second gear 1721 (e.g., a rack gear) engaged with the first gear 1711 and disposed in the sliding frame 160 (e.g., the plate portion 161). According to an embodiment, the motor 171 may be fixed to the receiving portion formed on the side surface of the bracket housing 115 through the motor bracket 173, and may be operatively coupled to the gear structure 172 fixed to the sliding frame 160. According to an embodiment, in the slide-in state, the electronic device 100 may include a first section T1 in which a portion visible to the outside of the flexible display 130 and a portion inserted into the inner space 1201 of the second housing 120 not to be visible to the outside overlap each other, and a second section T2 in which the portions do not overlap each other. According to an embodiment, the motor 171 of the driving module 170 may be disposed in at least a portion of the first section T1.

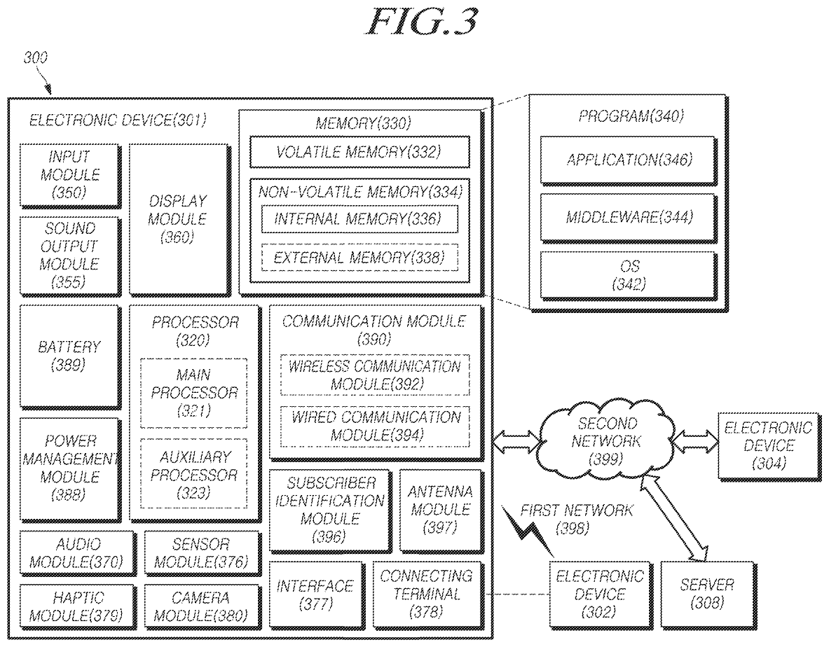

FIG. 3 is a block diagram illustrating an example electronic device 301 in a network environment 300 according to various embodiments. Referring to FIG. 3, the electronic device 301 in the network environment 300 may communicate with at least one of an electronic device 302 via a first network 398 (e.g., a short-range wireless communication network), or an electronic device 304 or a server 308 via a second network 399 (e.g., a long-range wireless communication network). According to an embodiment, the electronic device 301 may communicate with the electronic device 304 via the server 308. According to an embodiment, the electronic device 301 may include a processor 320, memory 330, an input module 350, a sound output module 355, a display module 360, an audio module 370, a sensor module 376, an interface 377, a connecting terminal 378, a haptic module 379, a camera module 380, a power management module 388, a battery 389, a communication module 390, a subscriber identification module (SIM) 396, or an antenna module 397. In an embodiment, at least one (e.g., the connecting terminal 378) of the components may be omitted from the electronic device 301, or one or more other components may be added in the electronic device 101. According to an embodiment, some (e.g., the sensor module 376, the camera module 380, or the antenna module 397) of the components may be integrated into a single component (e.g., the display module 360).

The processor 320 may include various processing circuitry. For example, as used herein, including the claims, the term “processor” may include various processing circuitry, including at least one processor, wherein one or more of at least one processor may be configured to perform various functions described herein. Additionally, the at least one processor may include a combination of processors performing various of the recited/disclosed functions. At least one processor may execute program instructions to achieve or perform various functions. The processor 320 may execute, for example, software (e.g., a program 340) to control at least one other component (e.g., a hardware or software component) of the electronic device 301 coupled with the processor 320, and may perform various data processing or computation. According to an embodiment, as at least part of the data processing or computation, the processor 320 may store a command or data received from another component (e.g., the sensor module 376 or the communication module 390) in volatile memory 332, process the command or the data stored in the volatile memory 332, and store resulting data in non-volatile memory 334. According to an embodiment, the processor 320 may include a main processor 321 (e.g., a central processing unit (CPU) or an application processor (AP)), or an auxiliary processor 323 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 301 includes the main processor 321 and the auxiliary processor 323, the auxiliary processor 323 may be configured to use lower power than the main processor 321 or to be specified for a designated function. The auxiliary processor 323 may be implemented as separate from, or as part of the main processor 321.

The auxiliary processor 323 may control at least some of functions or states related to at least one component (e.g., the display module 360, the sensor module 376, or the communication module 390) among the components of the electronic device 301, instead of the main processor 321 while the main processor 321 is in an inactive (e.g., sleep) state, or together with the main processor 321 while the main processor 321 is in an active state (e.g., executing an application). According to an embodiment, the auxiliary processor 323 (e.g., an image signal processor or a communication processor) may be implemented as part of another component (e.g., the camera module 380 or the communication module 390) functionally related to the auxiliary processor 123. According to an embodiment, the auxiliary processor 323 (e.g., the neural processing unit) may include a hardware structure specified for artificial intelligence model processing. The artificial intelligence model may be generated via machine learning. Such learning may be performed, e.g., by the electronic device 301 where the artificial intelligence is performed or via a separate server (e.g., the server 308). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 330 may store various data used by at least one component (e.g., the processor 320 or the sensor module 376) of the electronic device 301. The various data may include, for example, software (e.g., the program 340) and input data or output data for a command related thereto. The memory 330 may include the volatile memory 332 or the non-volatile memory 334.

The program 340 may be stored in the memory 330 as software, and may include, for example, an operating system (OS) 342, middleware 344, or an application 346.

The input module 350 may receive a command or data to be used by other component (e.g., the processor 320) of the electronic device 301, from the outside (e.g., a user) of the electronic device 301. The input module 350 may include, for example, a microphone, a mouse, a keyboard, keys (e.g., buttons), or a digital pen (e.g., a stylus pen).

The sound output module 355 may output sound signals to the outside of the electronic device 301. The sound output module 355 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 360 may visually provide information to the outside (e.g., a user) of the electronic device 301. The display 360 may include, for example, a display, a hologram device, or a projector and control circuitry to control a corresponding one of the display, hologram device, and projector. According to an embodiment, the display 360 may include a touch sensor configured to detect a touch, or a pressure sensor configured to measure the intensity of a force generated by the touch.

The audio module 370 may convert a sound into an electrical signal and vice versa. According to an embodiment, the audio module 370 may obtain the sound via the input module 350, or output the sound via the sound output module 355 or a headphone of an external electronic device (e.g., an electronic device 302) directly (e.g., wiredly) or wirelessly coupled with the electronic device 301.

The sensor module 376 may detect an operational state (e.g., power or temperature) of the electronic device 301 or an environmental state (e.g., a state of a user) external to the electronic device 101, and then generate an electrical signal or data value corresponding to the detected state. According to an embodiment, the sensor module 376 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 377 may support one or more specified protocols to be used for the electronic device 301 to be coupled with the external electronic device (e.g., the electronic device 302) directly (e.g., wiredly) or wirelessly. According to an embodiment, the interface 377 may include, for example, a high definition multimedia interface (HDMI), a universal serial bus (USB) interface, a secure digital (SD) card interface, or an audio interface.

A connecting terminal 378 may include a connector via which the electronic device 301 may be physically connected with the external electronic device (e.g., the electronic device 302). According to an embodiment, the connecting terminal 378 may include, for example, a HDMI connector, a USB connector, a SD card connector, or an audio connector (e.g., a headphone connector).

The haptic module 379 may convert an electrical signal into a mechanical stimulus (e.g., a vibration or motion) or electrical stimulus which may be recognized by a user via his tactile sensation or kinesthetic sensation. According to an embodiment, the haptic module 379 may include, for example, a motor, a piezoelectric element, or an electric stimulator.

The camera module 380 may capture a still image or moving images. According to an embodiment, the camera module 380 may include one or more lenses, image sensors, image signal processors, or flashes.

The power management module 388 may manage power supplied to the electronic device 301. According to an embodiment, the power management module 388 may be implemented as at least part of, for example, a power management integrated circuit (PMIC).

The battery 389 may supply power to at least one component of the electronic device 301. According to an embodiment, the battery 389 may include, for example, a primary cell which is not rechargeable, a secondary cell which is rechargeable, or a fuel cell.

The communication module 390 may support establishing a direct (e.g., wired) communication channel or a wireless communication channel between the electronic device 301 and the external electronic device (e.g., the electronic device 302, the electronic device 304, or the server 308) and performing communication via the established communication channel. The communication module 390 may include one or more communication processors that are operable independently from the processor 320 (e.g., the application processor (AP)) and supports a direct (e.g., wired) communication or a wireless communication. According to an embodiment, the communication module 390 may include a wireless communication module 392 (e.g., a cellular communication module, a short-range wireless communication module, or a global navigation satellite system (GNSS) communication module) or a wired communication module 394 (e.g., a local area network (LAN) communication module or a power line communication (PLC) module). A corresponding one of these communication modules may communicate with the external electronic device 304 via a first network 398 (e.g., a short-range communication network, such as Bluetooth™, wireless-fidelity (Wi-Fi) direct, or infrared data association (IrDA)) or a second network 399 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 392 may identify or authenticate the electronic device 301 in a communication network, such as the first network 398 or the second network 399, using subscriber information (e.g., international mobile subscriber identity (IMSI)) stored in the subscriber identification module 396.

The wireless communication module 392 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 392 may support a high-frequency band (e.g., the mmWave band) to achieve, e.g., a high data transmission rate. The wireless communication module 392 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 392 may support various requirements specified in the electronic device 301, an external electronic device (e.g., the electronic device 304), or a network system (e.g., the second network 399). According to an embodiment, the wireless communication module 392 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 397 may transmit or receive a signal or power to or from the outside (e.g., the external electronic device). According to an embodiment, the antenna module 397 may include one antenna including a radiator formed of a conductor or conductive pattern formed on a substrate (e.g., a printed circuit board (PCB)). According to an embodiment, the antenna module 397 may include a plurality of antennas (e.g., an antenna array). In this case, at least one antenna appropriate for a communication scheme used in a communication network, such as the first network 398 or the second network 399, may be selected from the plurality of antennas by, e.g., the communication module 390. The signal or the power may then be transmitted or received between the communication module 390 and the external electronic device via the selected at least one antenna. According to an embodiment, other parts (e.g., radio frequency integrated circuit (RFIC)) than the radiator may be further formed as part of the antenna module 397.

According to various embodiments, the antenna module 397 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 301 and the external electronic device 304 via the server 308 coupled with the second network 399. The external electronic devices 302 or 104 each may be a device of the same or a different type from the electronic device 301. According to an embodiment, all or some of operations to be executed at the electronic device 301 may be executed at one or more of the external electronic devices 302, 304, or 308. For example, if the electronic device 301 should perform a function or a service automatically, or in response to a request from a user or another device, the electronic device 301, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 301. The electronic device 301 may provide the outcome, with or without further processing of the outcome, as at least part of a reply to the request. To that end, a cloud computing, distributed computing, mobile edge computing (MEC), or client-server computing technology may be used, for example. The electronic device 301 may provide ultra low-latency services using, e.g., distributed computing or mobile edge computing. In an embodiment, the external electronic device 304 may include an Internet-of-things (IoT) device. The server 308 may be an intelligent server using machine learning and/or a neural network. According to an embodiment, the external electronic device 304 or the server 308 may be included in the second network 399. The electronic device 301 may be applied to intelligent services (e.g., smart home, smart city, smart car, or health-care) based on 5G communication technology or IoT-related technology.

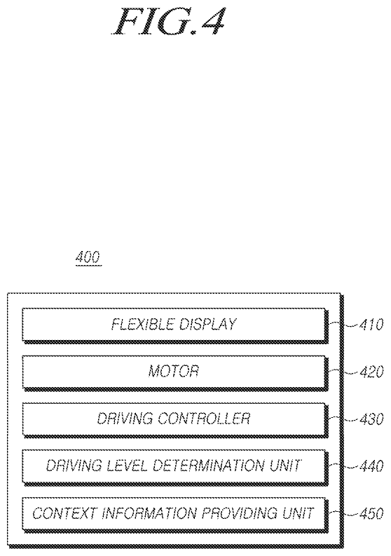

FIG. 4 is a block diagram illustrating an example configuration of an electronic device according to various embodiments. As illustrated, the electronic device 400 includes a flexible display 410, a motor 420, a driving controller (e.g., including processing and/or control circuitry) 430, a driving level determination unit (e.g., including various processing and/or control circuitry and/or executable program instructions) 440, and a context information providing unit (e.g., including various processing and/or control circuitry and/or executable program instructions) 450.

According to various embodiments of the disclosure, the flexible display 410 may include a display device in which the display screen externally visible to be able to display images to the user is varied. According to various embodiments, similar to the flexible display 130 illustrated in FIGS. 1 and 2, the flexible display 410 may be disposed so that a portion of the display is drawn into, e.g., rolled into, the inner space of the housing not to be visible to the outside or drawn out, e.g., stretched out, from the inner space of the housing according to a relative movement between the housings of the electronic device 400.

According to various embodiments of the disclosure, the motor 420 may be driven by the driving controller 430 to enable extension or reduction of the screen size visible to the outside of the flexible display 410, e.g., a relative movement between housings of the above-described electronic device 400, and accordingly, insertion or withdrawal of a portion of the display. According to various embodiments, the motor 420 and the driving controller 430 may correspond to, e.g., the driving module 170 including the driving motor 171 and the gear structure 172 of FIG. 1, but the disclosure is not limited thereto. According to various embodiments, the driving controller 430 may drive the motor 420 according to the driving level determined by the driving level determination unit 440 to be described below, in response to detecting that a predetermined event (e.g., pressing a predetermined button or key disposed on the electronic device 400 or touching a predetermined position on the display screen) of triggering the driving of the motor has occurred.

In various embodiments of the disclosure, the driving level for driving the motor 420 may be a time-speed function, e.g., a time-speed function defined by an initial driving speed for the motor 420 and an acceleration change over time. According to various embodiments of the disclosure, whenever the screen size visible to the outside of the flexible display 410 is extended or reduced, the driving controller 430 may drive the motor 420 according to the driving level determined by the driving level determination unit 440, e.g., a predetermined time-speed function, so that such extension or reduction is performed.

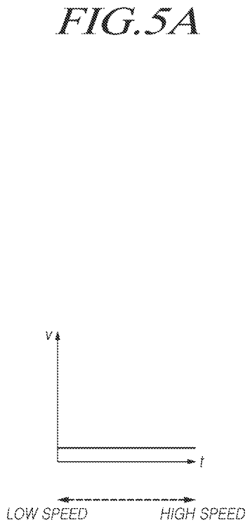

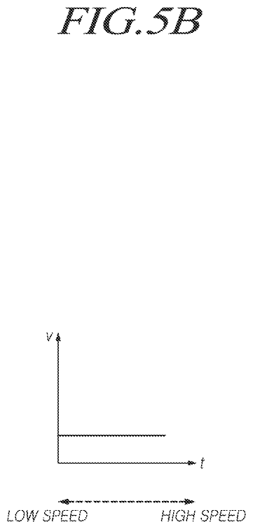

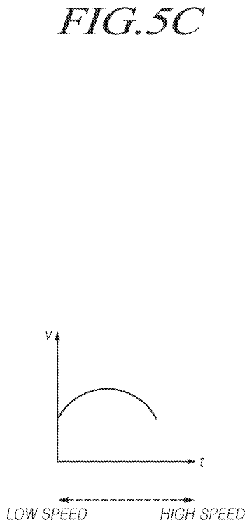

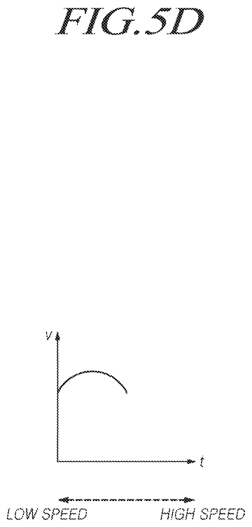

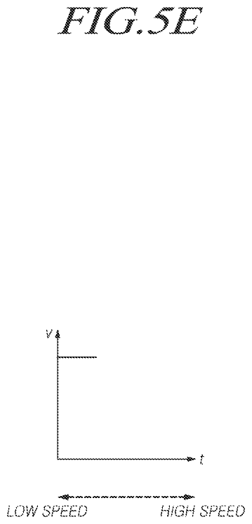

According to various embodiments, the driving level determination unit 440 may include various processing and/or control circuitry and/or executable program instructions and store a plurality of predefined driving levels, and may determine one of the plurality of driving levels described above as a driving level for the motor 420 by applying a predetermined criterion for each context based on various context information about the electronic device 400. According to various embodiments of the disclosure, the plurality of driving levels stored in the driving level determination unit 440 may be functions of speed over time that may be applied when driving the motor 420 to slide in or out the flexible display 410 as described above, e.g., extend or shrink the screen visible to the outside of the flexible display 410, and may be sequentially defined stepwise from the lower speed to higher. An example definition about a plurality of driving levels according to an embodiment of the disclosure is described below with reference to FIG. 5.

According to various embodiments of the disclosure, the driving level determination unit 440 may receive one or more pieces of context information about the electronic device 400 from the context information providing unit 450. According to various embodiments of the disclosure, when the motor 420 is driven to extend or shrink the flexible display 410, the context information providing unit 450 may obtain or gather one or more contexts designated to consider when determining the motor driving level to provide an optimal user experience based on the current context of the electronic device 400 comprehensively considering a user experience impediment (e.g., an issue caused by device operation speed deterioration) that may arise when the driving speed is low and a user experience impediment (e.g., noise or unstable grip issue) that may arise when the driving speed is high. According to an embodiment of the disclosure, the context information providing unit 450 may obtain information about the state of various components of the electronic device 400, various setting states, various sensor measurements, and other various use environment contexts at the time when the motor 420 is requested to be driven, and may transmit the obtained information to the driving level determination unit 440.

FIGS. 5A, 5B, 5C, 5D and 5E include various graphs each of motor driving levels for the electronic device 400 of FIG. 4, defined as a plurality of steps, according to various embodiments. As described above, according to various embodiments of the disclosure, each of the motor driving levels may be a time-speed function, e.g., a time-speed function defined by an initial driving speed for the motor 420 and an acceleration change over time, and in FIGS. 5A, 5B, 5C, 5D and 5E, differently defined time-speed functions are shown in a graph form.

As described above, various embodiments of the disclosure may define driving levels according to various stepwise speed patterns ranging from ultra-low speed to ultra-high speed in order to provide an optimal user experience appropriately considering a trade-off between fast device driving and noise/grip instability. Further, various embodiments of the disclosure may define driving levels in which deceleration/acceleration is applied in the middle of driving the motor 420 from a point of view of providing natural motor driving and emotional quality.

FIG. 5A illustrates an ultra-low speed/constant speed driving level pattern which is the minimum level among a plurality of motor driving levels defined in an embodiment of the disclosure. Here, “ultra-low speed” may refer, for example, to having a speed lower than the speed of each driving level pattern illustrated in FIGS. 5B, 5C, 5D and 5E. Further, “constant speed” here may refer, for example, to maintaining a constant speed without changing the speed over time. As illustrated in FIG. 5A, it may be seen that the driving level of the motor is maintained at a constant speed, which is lower than each driving level illustrated in FIGS. 5B, 5C, 5D and 5E.

FIG. 5B illustrates a low speed/constant speed driving level pattern which is a second level among the plurality of motor driving levels defined in an embodiment of the disclosure. Here, “low speed” may refer, for example, to having a speed higher than that in FIG. 5A but lower than the speed of each driving level pattern illustrated in FIGS. 5C, 5D and 5E. As illustrated in FIG. 5B, it may be seen that a constant speed, which is lower than each driving level illustrated in FIGS. 5C, 5D and 5E is maintained without changing over time.

FIG. 5C illustrates an intermediate speed/acceleration/deceleration driving level pattern which is a third level among the plurality of motor driving levels defined in an embodiment of the disclosure. Here, “intermediate speed” may refer, for example, to having a speed higher than that in FIGS. 5A and 5B but lower than the speed of each driving level pattern illustrated in FIGS. 5D and 5E, and “deceleration/acceleration” may refer, for example, to having a change in acceleration in the form of the speed increasing and then decreasing over time. As illustrated in FIG. 5C, it may be seen that a parabolic variable speed pattern is shown that gradually increases for a predetermined time from the beginning of time (e.g., the beginning of the motor operation) and then decreases for a predetermined time in a range lower than each driving level illustrated in of FIGS. 5D and 5E.

FIG. 5D illustrates a high speed/acceleration/deceleration speed driving level pattern which is a fourth level among the plurality of motor driving levels defined in an embodiment of the disclosure. Here, “high speed” may refer, for example, to having a speed higher than that in FIGS. 5A, 5B and 5C but lower than the speed of the driving level pattern illustrated in FIG. 5E. As illustrated in FIG. 5D, it may be seen that a parabolic variable speed pattern is shown that gradually increases for a predetermined time from the beginning of time (e.g., the beginning of the motor operation) and then decreases for a predetermined time in a range higher than the driving level illustrated in FIG. 5C and lower than the driving level illustrated in FIG. 5E.

FIG. 5E illustrates an ultra-high speed/constant speed driving level pattern which is the maximum level among a plurality of motor driving levels defined in an embodiment of the disclosure. Here, “ultra-high speed” may refer, for example, to having a speed higher than the speed of each driving level pattern illustrated in FIGS. 5A, 5B, 5C and 5D. As illustrated in FIG. 5E, it may be seen that a constant speed, which is higher than each driving level illustrated in FIGS. 5A, 5B, 5C and 5D is maintained without changing over time.

As the level increases from the minimum level of (a) of FIG. 5A to the maximum level of FIG. 5E among the motor driving levels illustrated in FIGS. 5A, 5B, 5C, 5D and 5E, the noise caused by motor driving may gradually increase, and the resultant user experience impediments may gradually increase accordingly. As illustrated, as the level increases from the minimum level of FIG. 5A to the maximum level of FIG. 5E, the time at which the operation is completed may be gradually shortened. Accordingly, according to various embodiments of the disclosure, as low a driving level as possible may be selected in a situation where low noise is important, and as high a driving level as possible may be selected in a situation where fast operation is important. Meanwhile, according to various embodiments of the disclosure, as illustrated in FIGS. 5C and 5D, when the motor 420 of the electronic device 400 is driven by the driving level to which the acceleration/deceleration is applied, a natural device movement may be made when a form factor change of the electronic device 400 occurs (e.g., when the flexible display is inserted or withdrawn and the screen is extended or reduced accordingly) according to the driving of the motor, and the emotional quality may be implemented accordingly. However, when the motor 420 is driven according to the driving level to which the acceleration/deceleration is applied, noise may usually be caused due to such acceleration/deceleration, thereby hindering the user's use experience. According to various embodiments of the disclosure, when an appropriate driving level is determined considering the context of the electronic device 400, the implementation of the emotional quality according to such acceleration/deceleration and the impediments to the use experience due to noise may be considered together.

Meanwhile, in the drawings, driving levels defined as five steps are illustrated, but this is merely an example, but the disclosure is not limited thereto. According to various embodiments of the disclosure, a larger or smaller number of levels may be variously defined as various time-speed functions, respectively. Further, according to various embodiments of the disclosure, the plurality of variously defined driving levels (time-speed functions) may be assigned steps in the order in which the average speed increases from the minimum level (the lowest average speed among the plurality of levels) to the maximum level (the highest average speed among the plurality of levels).

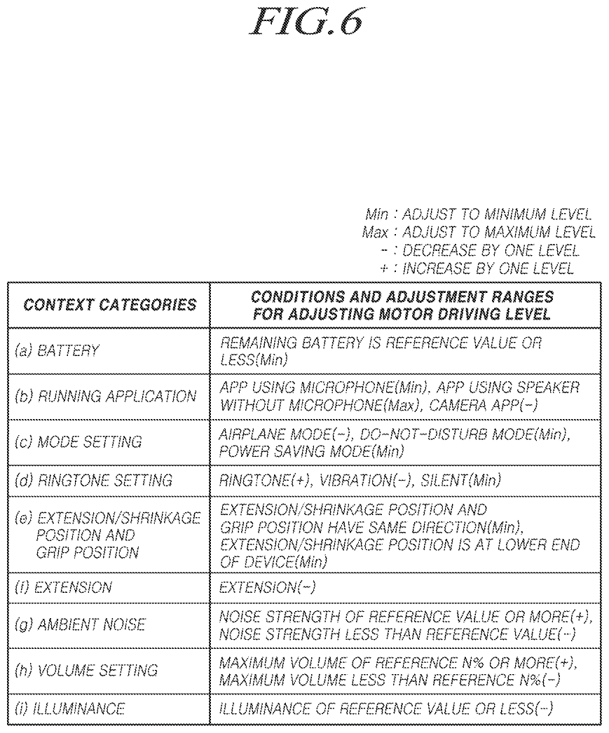

FIG. 6 is a table illustrating categories of example context information that may be used to adjust the driving level of a motor 420 by the driving level determination unit 440 of FIG. 4 and example conditions and the respective corresponding adjustment ranges for adjusting each motor driving level for each context category, according to various embodiments. In the drawings, a corresponding criterion is marked ‘Max’ if the driving level of the motor 420 is adjusted to the maximum level, e.g., the level of the highest speed, among the plurality of driving levels when a predetermined condition is met under the assumption that there are a plurality of driving levels predefined stepwise. Likewise, a corresponding criterion is marked ‘Min’ if the driving level of the motor 420 is adjusted to the minimum level, e.g., the level of the lowest speed, among the plurality of driving levels when a predetermined condition is met. Further, a corresponding criterion is marked ‘(+)’ or ‘(−)’ if the driving level of the motor 420 needs to be one step higher or lower than the previous level when a predetermined criterion is met. The categories of context information considered to adjust the driving level of the motor 420 and the driving level adjustment ranges of the motor 420 according to each condition for each context category are merely examples, and context information of other various categories may be used, and various conditions and adjustment ranges may be defined and applied to determine the driving level of the motor 420 according to embodiments of the disclosure. According to an embodiment of the disclosure, each state information of the context category displayed in the drawings may be provided to the driving level determination unit 440 by the context information providing unit 450.

According to an embodiment of the disclosure, the context information providing unit 450 may obtain, e.g., (a) battery context, e.g., remaining battery capacity (state of charge (SOC)) information about the electronic device 400, and provide the obtained state of charge (SOC) information to the driving level determination unit 440. Referring to FIG. 6, when the condition that the remaining capacity of the battery is less than or equal to a predetermined reference value (e.g., 10%) is met, the driving level determination unit 440 may adjust the driving level of the motor 420 to the minimum level among the plurality of predefined driving levels. In the drawings, it is illustrated that the battery context is considered for adjusting the driving level, but the disclosure is not limited thereto. According to an embodiment of the disclosure, if the change in the driving level of the motor 420 does not significantly affect battery consumption, the battery context may not be considered for adjusting the driving level of the motor.

According to an embodiment of the disclosure, the context information providing unit 450 may provide the driving level determination unit 440 with, e.g., (b) application context while being executed, e.g., information about whether there is an application currently in an active state on the electronic device 400 among applications predetermined to be considered for determining the driving level, and, if any, which the application is. According to an embodiment, for example, an application using a microphone (e.g., phone application, video call application, or voice recording application), an application using a speaker without a microphone (e.g., music play application), and a camera application may be predetermined as applications to be considered for determining the driving level, but the disclosure is not limited thereto. Referring to FIG. 6, when an application (e.g., voice recording, camera, phone, etc.) using a microphone is being executed, the driving level determination unit 440 may adjust the driving level of the motor 420 to the minimum level among the plurality of driving levels. Referring to FIG. 6, when an application using a speaker without using a microphone is being executed (e.g., a media player, a web browser, etc.), the driving level determination unit 440 may adjust the driving level of the motor 420 to the maximum level among the plurality of driving levels. Referring to FIG. 6, when the camera application is being executed, the driving level determination unit 440 may adjust the driving level of the motor 330 to be one step lower than the current level. In general, when an application that uses a microphone is being executed, application user experience may be further deteriorated as noise due to motor driving increases and, when an application using a speaker is being executed, user experience may be significantly deteriorated as noise due to motor driving lasts longer although it is at low level. For this reason, as shown in the drawings, the driving level determination unit 440 may adjust the driving level of the motor 420, but the disclosure is not limited thereto. Applications determined to be considered to determine the driving level of the motor 330 and the range of adjustment of the driving level according to execution of each application may be determined differently from those shown in the drawings according to various embodiments of the disclosure.

According to an embodiment of the disclosure, the context information providing unit 450 may provide the driving level determination unit 440 with, e.g., (c) mode setting context, e.g., information about whether a predetermined mode among predetermined modes is set on the electronic device 400. According to an embodiment, e.g., as modes to be considered as the mode setting context, modes for restricting some functions of the electronic device 400, e.g., an airplane mode, a do-not-disturb mode, and a power saving mode may be determined, but the disclosure is not limited thereto. According to an embodiment of the disclosure, when any one of the above-described modes is set on the electronic device 400, the context information providing unit 450 may provide such information to the driving level determination unit 440. As illustrated in FIG. 6, when a do-not-disturb mode or a power saving mode is set on the electronic device 400, the driving level determination unit 440 may adjust the driving level of the motor 420 to the minimum level among the plurality of driving levels to respect the user intent according to each mode setting. As illustrated in FIG. 6, when the airplane mode is set on the electronic device 400, the driving level determination unit 440 may adjust the driving level of the motor 420 to be one step lower than the current level among the plurality of driving levels. The modes determined to be considered to determine the driving level of the motor 330 and the range of adjustment of the driving level according to each mode setting may be determined differently from those shown in the drawings according to various embodiments of the disclosure.

According to an embodiment of the disclosure, the context information providing unit 450 may obtain, e.g., (d) ringtone setting context, e.g., ringtone setting state information about the electronic device 400, and provide the obtained ringtone setting state information to the driving level determination unit 440. According to an embodiment of the disclosure, when the electronic device 400 is, e.g., a mobile phone, the ringtone setting may be set to one of a ringtone mode, a vibration mode, and a silent mode. According to an embodiment, the context information providing unit 450 may identify the ringtone setting mode of the electronic device 400 and provide the identified ringtone setting mode to the driving level determination unit 440. As illustrated in FIG. 6, when the ringtone setting on the electronic device 400 is the ringtone mode, the driving level determination unit 440 may adjust the driving level of the motor 420 to be one step higher than the current level among the plurality of driving levels. As illustrated in FIG. 6, when the ringtone setting on the electronic device 400 is the vibration mode, the driving level determination unit 440 may adjust the driving level of the motor 420 to be one step lower than the current level among the plurality of driving levels. As illustrated in FIG. 6, when the ringtone setting on the electronic device 400 is the silent mode, the driving level determination unit 440 may adjust the driving level of the motor 420 to the minimum level among the plurality of driving levels. In general, the ringtone mode may be set in a context less sensitive to noise, and the silent mode may be set in a context more sensitive to noise. For this reason, as shown in the drawings, the driving level determination unit 440 may adjust the driving level of the motor 440, but the disclosure is not limited thereto. According to various embodiments of the disclosure, the range of adjustment of the driving level according to the setting of each ringtone mode may be determined differently from that illustrated in the drawings.

According to an embodiment of the disclosure, the context information providing unit 450 may obtain, e.g., (e) extension/shrinkage position and grip position context, e.g., information about which direction the externally exposed screen of the flexible display 410 is extended or shrunk among the right, left, upper, and lower directions in the electronic device 400, and/or whether the position of the user's hand currently gripping the electronic device 400 is the right or left of the electronic device 400 and provide the information to the driving level determination unit 440. According to an embodiment of the disclosure, the grip position of the user may be detected based on, e.g., a touch screen sensor, a touch detection sensor, and other pressure or electrostatic sensors disposed on the flexible display 410 of the electronic device 400, but the disclosure is not limited to a specific example. As shown in FIG. 6, when the side where the screen of the flexible display 410 is extended or shrunk with respect to the electronic device 400 is the right side (or left side), if the position of the user's grip on the electronic device 400 is likewise on the right side (or left side) of the electronic device 400, the driving level determination unit 440 may adjust the driving level of the motor 420 to the minimum level among the plurality of driving levels. Further, as shown in FIG. 6, when the flexible display 410 is extended or shrunk downward with respect to the electronic device 400, the driving level determination unit 440 may adjust the driving level of the motor 420 to the minimum level among the plurality of driving levels. In general, when the position where the flexible display 410 is extended or shrunk and the position of the user's grip are on the same side of the electronic device 400, or when such extension or shrinkage occurs on a lower side of the electronic device 400, if the driving speed of the motor 420 is high, the stability of grip on the electronic device 400 may be deteriorated. For this reason, as shown in the drawings, the driving level determination unit 440 may adjust the driving level of the motor 420, but the disclosure is not limited thereto. The conditions for determining the driving level of the motor 330 and the range of adjustment of the driving level may be determined differently from those shown in the drawings according to embodiments of the disclosure.

According to an embodiment of the disclosure, the context information providing unit 450 may provide the driving level determination unit 440 with, e.g., (f) extension context, e.g., whether the screen of the flexible display 410 is extended in the electronic device 400 according to the driving of the motor 420. As illustrated in FIG. 6, when the screen of the flexible display 410 of the electronic device 400 is extended according to the driving of the motor 420, the driving level determination unit 440 may adjust the driving level of the motor 420 to be one step lower than the current level. In general, when extending the screen, use stability may be further deteriorated, and noise sensitivity may be higher than when shrinking the screen, due to high motor driving speed, whereas operation immediacy is further prioritized in shrinkage of the screen in many cases (e.g., when terminating the operation). For this reason, as shown in the drawings, the driving level determination unit 440 may adjust the driving level of the motor 420, but the disclosure is not limited thereto. The conditions for determining the driving level of the motor 330 and the range of adjustment of the driving level may be determined differently from those shown in the drawings according to embodiments of the disclosure.

According to an embodiment of the disclosure, the context information providing unit 450 may provide the driving level determination unit 440 with, e.g., (g) ambient noise context, e.g., the strength state of the ambient noise of the electronic device 400. According to an embodiment, e.g., the electronic device 400 may include a noise measurement sensor (e.g., a plurality of microphones, etc.), and the context information providing unit 450 may obtain the strength of the noise measured by the noise measurement sensor and may transfer the strength of the noise to the driving level determination unit 440. As illustrated in FIG. 6, when the strength of the noise is larger than or equal to a reference value, the driving level determination unit 440 may adjust the driving level of the motor 420 to be one step higher than the current level. Referring to FIG. 6, when the strength of the noise is less than the reference value, the driving level determination unit 440 may adjust the driving level of the motor 420 to be one step lower than the current level. In general, for the reason why it may be less sensitive to noise due to motor driving when the ambient noise strength is high, as shown in the drawings, the driving level determination unit 440 may adjust the driving level of the motor 420, but the disclosure is not limited thereto.

According to an embodiment of the disclosure, the context information providing unit 450 may provide the driving level determination unit 440 with, e.g., (h) volume setting context, e.g., volume information about the volume (e.g., a ringtone volume) set on the electronic device 400. Referring to FIG. 6, when the set volume is larger than or equal to a predetermined reference % of the volume maximum, the driving level determination unit 440 may adjust the driving level of the motor 420 to be one step higher than the current level. Referring to FIG. 6, when the set volume level is less than the predetermined reference % of the volume maximum, the driving level determination unit 440 may adjust the driving level of the motor 420 to be one step lower than the current level. In general, for the reason why it may be less sensitive to noise due to motor driving when the volume of the electronic device is set to be high, as shown in the drawings, the driving level determination unit 440 may adjust the driving level of the motor 420, but the disclosure is not limited thereto.

According to an embodiment of the disclosure, the context information providing unit 450 may provide the driving level determination unit 440 with, e.g., (i) illuminance context, e.g., an ambient illuminance value of the electronic device 400. According to an embodiment, e.g., the electronic device 400 may include an illuminance sensor, and the context information providing unit 450 may obtain an illuminance value measured by the illuminance sensor and transfer the illuminance value to the driving level determination unit 440. As illustrated in FIG. 6, when the illuminance value is less than or equal to a reference value, the driving level determination unit 440 may adjust the driving level of the motor 420 to be one step lower than the current value. In general, for the reason why it may be less sensitive to noise due to motor driving when the surroundings are quiet, as shown in the drawings, the driving level determination unit 440 may adjust the driving level of the motor 420, but the disclosure is not limited thereto.

According to various embodiments of the disclosure, the driving level determination unit 440 may determine the driving level for the motor 420 by selectively applying one or more context categories among the context categories of (a) to (i) described above. According to various embodiments of the disclosure, the context categories applied by the driving level determination unit 440 to determine the driving level for the motor 420 and conditions and adjustment ranges respectively corresponding thereto may be dynamically changed according to a user setting or a device setting. Further, according to various embodiments, the driving level determination unit 440 may sequentially review each context category to be considered for determining the driving level for the motor 420 according to priority, and may sequentially apply a condition and an adjustment range determined for each category. For example, according to an embodiment of the disclosure, the context categories (a) to (i) illustrated in FIG. 6 may be sequentially prioritized from the top, and the driving level determination unit 440 may sequentially review the context categories (a) to (i) from the top and apply each predetermined condition and adjustment range. According to various embodiments of the disclosure, the context categories to be considered for determining the driving level of the motor 420 may be bundled into several groups, each group may be assigned a group priority, and they may be sequentially reviewed according to the group priorities, but the disclosure is not limited thereto.

According to various embodiments of the disclosure, the context information providing unit 450 may obtain various context category information regarding the electronic device 400, e.g., location information (e.g., home, workplace, school, preregistered place, or non-preregistered place) about the electronic device 400, current time information (e.g., daytime or night time), context information (e.g., in a meeting), and other various information, in addition to the above-described category context information and transfer the obtained information to the driving level determination unit 440. Further, although not shown in the drawings, according to an embodiment of the disclosure, e.g., when a hearing assistance mode (accessibility mode) is set on the electronic device 400, the context information providing unit 450 may provide such information to the driving level determination unit 440 to be considered when adjusting the driving level for the motor 420. For example, a user with a hearing impairment may not directly recognize noise caused by driving the motor of the electronic device 400, and a situation in which the user does not directly recognize such noise when the motor is driven at high speed may sometimes cause an uncomfortable situation. Thus, according to an embodiment of the disclosure, when the hearing assistance mode is set, the driving level of the motor 420 may be lowered or restricted from exceeding a certain level, but the disclosure is not limited to a specific type. According to various embodiments of the disclosure, the conditions and adjustment ranges as to how the driving level determination unit 440 is to adjust the driving level for the motor 420 according to the state of each obtained context information may be defined and applied in various ways.

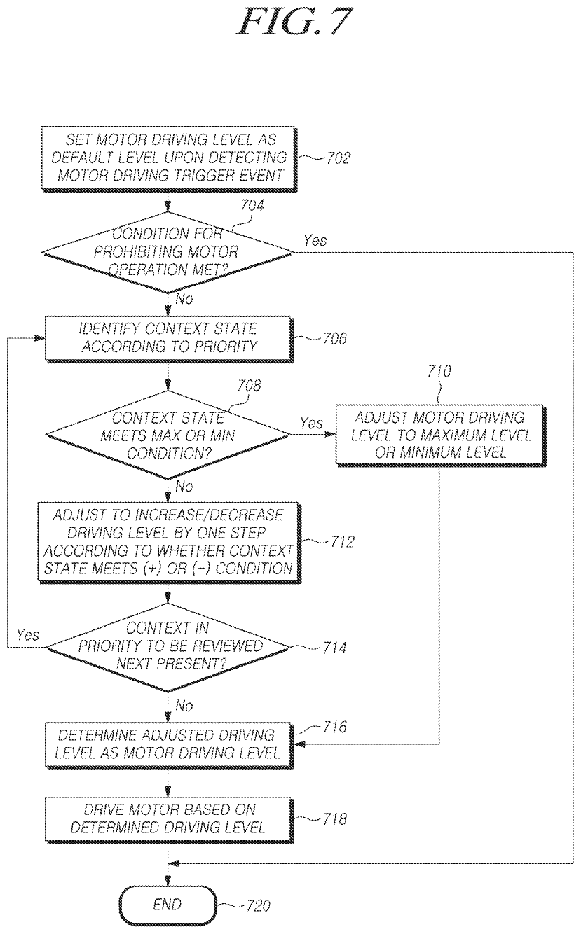

FIG. 7 is a flowchart illustrating example operations of a procedure for determining a driving level of a motor 420 by the driving level determination unit 440 of FIG. 4 according to various embodiments.

In step 702, the driving level determination unit 440 may detect that an event for triggering motor driving has occurred, and set the driving level of the motor as a default level. In operation 704, it may be identified whether a condition in which the operation (driving) of the motor 420 is prohibited is met (e.g., when driving of the motor 420 and the extension of the display according thereto are prohibited in a case where a lock mode or a kids lock mode is set on the electronic device 400, such a condition is met). In step 704, if the condition for prohibiting driving of the motor 420 is met, the procedure may proceed to step 720 to end.

When it is determined that the condition for prohibiting driving of the motor 420 is not met in operation 704, the procedure may proceed to step 706, identifying the state of the electronic device 400 for each context category according to priority. In step 708, it is determined whether the state of the context identified in step 706 meets the condition determined to adjust the driving level of the motor 420 to the maximum level or the minimum level, and if it is determined so, the procedure may proceed to step 710. In step 710, the driving level of the motor 420 may be adjusted to the maximum level or the minimum level according to a predetermined condition and the criteria of the adjustment range, and the procedure may proceed to step 716.

If the determination result in step 708 indicates that the identified state of the context of the electronic device 400 does not meet the condition determined to adjust the driving level of the motor 420 to the maximum level or the minimum level, the procedure may proceed to step 712. In step 712, it may be determined whether the state of the context meets the condition determined to increase or decrease the driving level of the motor 420 by one step, and the driving level of the motor 420 may be increased or decreased by one step according to a result of the determination.

The procedure may proceed to step 714 to determine whether the context category of the priority to be reviewed next remains and, if so, the procedure may return to step 706 to continue the procedure. When it is determined that there is no context category of the priority to be further reviewed in step 714, the procedure may proceed to step 716. In step 716, the driving level, which is the result adjusted according to the procedure flow, may be determined as the final driving level of the motor 420. In step 718, the driving controller 430 may be controlled to drive the motor 420 at the determined driving level of the motor 420, and the procedure may be terminated.

In the disclosure, “determine” the driving level of a motor may refer, for example, to finally determining the driving level of the motor without the need for adjusting the driving level according to other context conditions, as the final result of comprehensively considering several conditions of several contexts or based on a specific condition of a specific context. In the disclosure, “adjust” the driving level may refer, for example, to temporarily increasing/decreasing the driving level with each context condition reflected until the final result is derived while sequentially reviewing the conditions of each context.

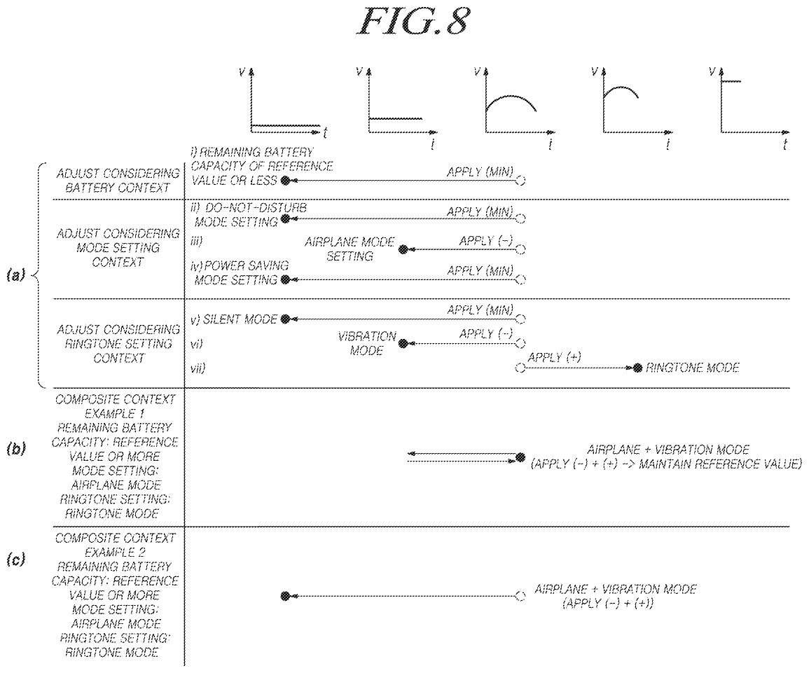

FIG. 8 is a diagram illustrating various examples of adjusting a driving level of a motor 420 based on some context categories shown in FIG. 6 and the driving level (e.g., five steps) classification shown in FIGS. 5A, 5B, 5C, 5D and 5E, according to various embodiments.

(a) of FIG. 8 illustrates a situation in which the driving level of a motor is adjusted for each condition considering a battery context, a mode setting context, or a ringtone setting context. For example, (a) of FIG. 8 illustrates each of a context of adjusting the motor driving level from a predetermined reference level (e.g., intermediate/acceleration/deceleration applied levels of three levels as shown) to the minimum level (e.g., ultra-low speed/constant speed level of one level as shown) (i) when the remaining battery capacity is a reference value or less considering the battery context, a context of adjusting the motor driving level from the reference level to the minimum level (ii) when the do-not-disturb mode is set or (iv) the power saving mode is set and adjusting the motor driving level to be one step lower than the reference level (iii) when the airplane mode is set, according to the mode setting context, and a context of adjusting the motor driving level from the reference level to the minimum level (v) when the silent mode is set, adjusting the motor driving level to be one step lower than the reference level (vi) when the vibration mode is set, and adjusting the motor driving level to be one step higher than the reference level (vii) when the ringtone mode is set, according to the ringtone setting context.

(b) of FIG. 8 illustrates an example context of adjusting the driving level of the motor, e.g., when the remaining battery capacity is a reference value or more, the airplane mode is set, and the ringtone mode is set, as a case in which the battery context, the mode setting context, and the ringtone setting context all are considered. For example, (b) of FIG. 8 illustrates a context in which the battery context does not affect adjustment of the driving level of the motor, the driving level is one step reduced from the reference level according to the airplane mode setting and, then, according to the ringtone mode setting, is further one step increased, thereby maintaining the original reference level.

(c) of FIG. 8 illustrates another example context of adjusting the driving level of the motor, e.g., when the remaining battery capacity is a reference value or more, the airplane mode is set, and the vibration mode is set, as a case in which the battery context, the mode setting context, and the ringtone setting context all are considered. For example, (b) of FIG. 8 illustrates a context in which the battery context does not affect adjustment of the driving level of the motor, the driving level is one step reduced from the reference level according to the airplane mode setting and, then, according to the vibration mode setting, is further one step reduced, thereby adjusting the driving level to be two steps lower than the original reference level.

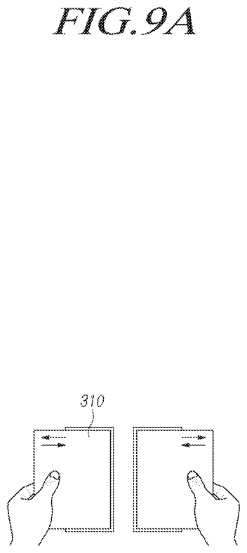

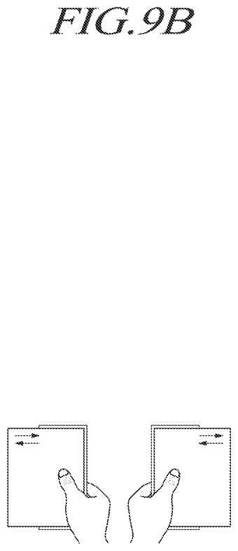

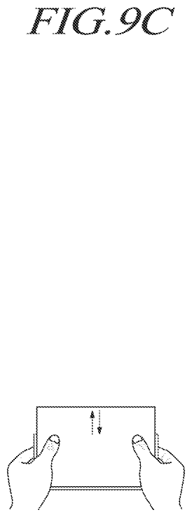

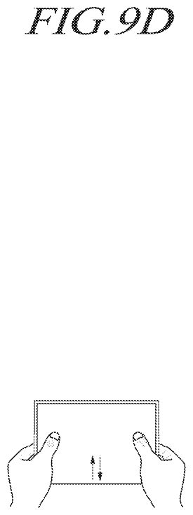

According to various embodiments of the disclosure, as described above, the driving level determination unit 440 may adjust the driving level of the motor 420 considering the extension/shrinkage position and the grip position context. Hereinafter, various embodiments of adjusting the driving level of the motor 420 and partially modifying or restricting the driving of the motor 420 considering the extension/shrinkage position and grip position context, among various contexts related to the electronic device 400 are described with reference to FIGS. 9 to 12.

FIGS. 9A, 9B, 9C and 9D are diagrams illustrating various contexts in which an externally visible screen area is extended or shrunk as a portion of a flexible display 410 is slid in or out of a housing according to various embodiments.

For example, FIG. 9A illustrates a case where the user grips the same side as the side where extension or shrinkage of the electronic device 400 occurs (the arrows indicate the directions of extension or shrinkage) when extension or shrinkage of the screen area of the flexible display 410 occurs to the left or right of the electronic device 400 while the electronic device 400 is positioned in the portrait mode. FIG. 9B illustrates a case where the user grips the side other than the side where extension or shrinkage of the electronic device 400 occurs when extension or shrinkage of the screen area of the flexible display 410 occurs to the left or right of the electronic device 400 and the electronic device 400 is positioned in the portrait mode like in FIG. 9A. FIGS. 9C and 9D illustrate cases where extension or shrinkage of the screen area of the flexible display 410 occurs at an upper end and a lower end of the electronic device 400 while the electronic device 400 is positioned in the landscape mode. When the user grips the same side as the side where extension or shrinkage of the screen area of the flexible display 410 occurs as in FIG. 9A or when extension or shrinkage of the screen area of the flexible display 410 occurs at a lower end of the electronic device 400 in the landscape mode as in FIG. 9D, the user's grip may be momentarily unstable due to the extension or shrinkage.

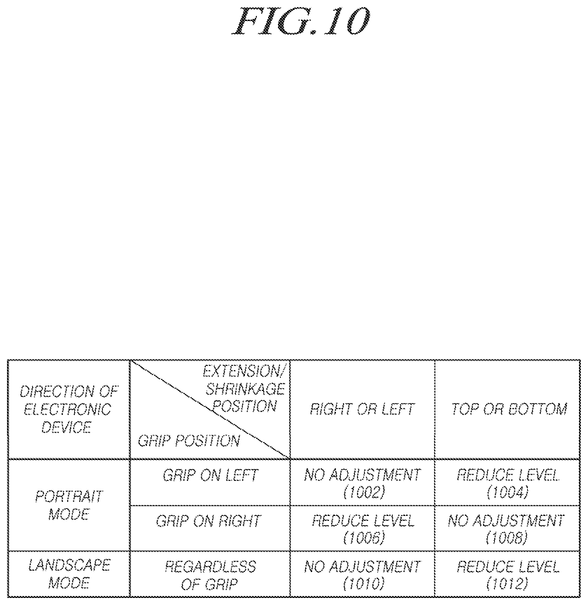

FIG. 10 is a chart illustrating example criteria of adjusting a driving level for each condition considering an extended/shrunk position and grip position context according to various embodiments. For example, FIG. 10 illustrates example criteria for adjusting the driving level considering the extension/shrinkage position and grip position context, e.g., the side of the electronic device 400 where extension or shrinkage occurs and/or the position of the user's grip on the electronic device 400, in various contexts in which the externally visible screen area of the flexible display 410 is extended or shrunk as a portion of the flexible display 410 is slid in or out from the housing as shown in FIGS. 9A, 9B, 9C and 9D.

For example, as shown in FIG. 10, in a state (e.g., the second figure of (b) of FIG. 9) in which extension or shrinkage of the flexible display 410 occurs on the right side of the electronic device 400 and the grip on the electronic device 400 is had by the left hand (e.g., the left side of the electronic device) or a state in which (e.g., the first figure of FIG. 9B) in which extension or shrinkage of the flexible display 410 occurs on the left side of the electronic device 400 and the grip on the electronic device 400 is had by the right hand (e.g., the right side of the electronic device) when the direction of the electronic device 400 is in the portrait mode, each state does not affect adjustment of the driving level (reference numerals 1002 and 1008). As shown in FIG. 10, in a state (e.g., the second figure of FIG. 9A) in which extension or shrinkage of the flexible display 410 occurs on the right side of the electronic device 400 and the grip on the electronic device 400 is had by the right hand (e.g., the right side of the electronic device) or a state in which (e.g., the first figure of FIG. 9A) in which extension or shrinkage of the flexible display 410 occurs on the left side of the electronic device 400 and the grip on the electronic device 400 is had by the left hand (e.g., the left side of the electronic device) when the direction of the electronic device 400 is in the portrait mode, each state is shown as leading to a decrease in the driving level (reference numerals 1004 and 1006). As such, in this example, in the portrait mode, when the position where extension or shrinkage of the flexible display 410 occurs is on the same side as the position of the user's grip on the electronic device 400, the driving level is decreased considering a context where such grip instability occurs.

As shown in FIG. 10, in a state (e.g., FIG. 9C) in which extension or shrinkage of the flexible display 410 occurs on an upper side of the electronic device 400 when the terminal direction mode is the landscape mode, such state does not affect adjustment of the driving level regardless of the grip position (reference numeral 1010). In a state (e.g., FIG. 9D) in which extension or shrinkage of the flexible display 410 occurs on a lower side of the electronic device 400 when the terminal direction mode is the landscape mode, such state may lead to a decrease in the driving level regardless of the grip position (reference numeral 1012).

Meanwhile, according to the driving level adjustment criteria of the extension/shrinkage position and grip position context shown in FIG. 6E, the driving level of the motor is determined to be adjusted to the minimum level when the position where extension or shrinkage of the screen area occurs and the grip position are on the same side of the electronic device 400 and when the position where extension or shrinkage of the screen area occurs is on a lower side of the electronic device. FIG. 10 discloses simply adjusting the driving level for the same context (e.g., each context corresponding to FIG. 9A or FIG. 9D) as described above. However, according to various embodiments of the disclosure, decreasing the driving level may be adjusting the driving level to the minimum level as shown in FIG. 6E or decreasing the driving level by one step according to the user or device settings, but the disclosure is not limited thereto.

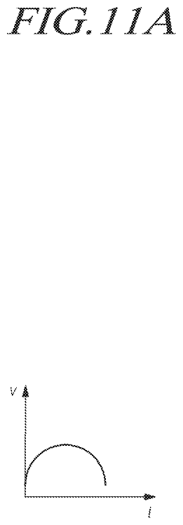

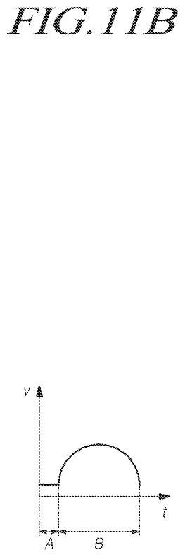

FIGS. 11A and 11B are diagrams illustrating an example of partially modifying driving according to a driving level of a motor 420 to enhance grip stability when extending or shrinking a screen area of a flexible display 410 according to various embodiments.

For example, FIG. 11A illustrates a driving level pattern when driving a motor 420 at a selected driving level for an entire time when the motor 420 is driven when a specific driving level for the motor 420, e.g., an intermediate speed/acceleration/deceleration applied pattern similar to FIG. 5C, is selected according to a predetermined criterion, for comparison with FIG. 11B. FIG. 11B illustrates a modified driving level pattern in which, as shown in FIG. 11A, when a specific driving level for the motor 420, e.g., an intermediate speed/acceleration/deceleration applied pattern similar to FIG. 5C, is selected, the entire time for driving the motor 420 is divided into an initial A period and a subsequent remaining B period, the motor 420 is driven at a predetermined driving level (e.g., an ultra-low speed/constant speed pattern similar to FIG. 5A) during the initial A period, and then, the motor 420 is driven at the selected driving level during the remaining B period.

For example, according to an embodiment of the disclosure, when the extension/shrinkage position and grip position context corresponds to reference numerals 1002, 1008, and 1010 of FIG. 10, the motor 420 for extending or shrinking the flexible display 410 may be driven according to the driving level pattern illustrated in FIG. 11A. According to an embodiment of the disclosure, when the extension/shrinkage position and grip position context corresponds to reference numerals 1004, 1006, and 1012 of FIG. 10, the motor 420 for extending or shrinking the flexible display 410 may be driven according to the modified driving level pattern illustrated in FIG. 11B, but the disclosure is not limited thereto.

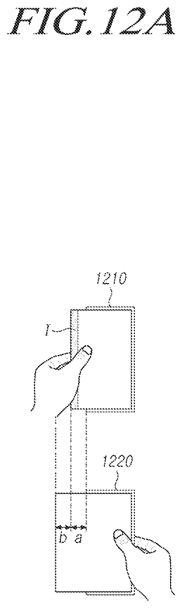

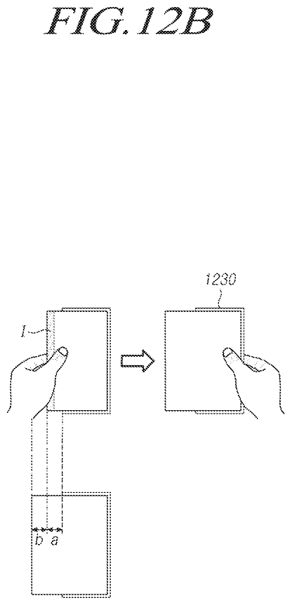

FIGS. 12A and 12B are diagrams illustrating a modified example of restricting extension of a screen area of a flexible display 410 to a predetermined range to enhance grip stability when extending the screen area of the flexible display 410 according to various embodiments.

For example, at the top 1210 of FIG. 12A, a modified example is illustrated in which extension of the screen area is restricted to a limited range (section a) of the entire extendable range (section a+b) when the side where extension of the screen area of the flexible display 410 occurs and the position of the user's grip are on the same side of the electronic device 400 (e.g., when correspond to reference numerals 1004 and 1006 of FIG. 10). The modified example 1210 illustrated at the top of FIG. 12A may be more clearly understood from comparison with when extension occurs in the entire extendable range (section a+b) when the side where extension of the screen area of the flexible display 410 occurs and the position of the user's grip are on different sides of the electronic device 400 (e.g., when correspond to reference numerals 1002 and 1008), illustrated at the bottom 1220 of FIG. 12A. According to various embodiments of the disclosure, the range (section a) in which extension of the screen area is restricted may be determined to be 50% of the entire extendable range (section a+b) or may be determined in other various manners.

Meanwhile, according to an embodiment of the disclosure, when the side where extension of the screen area of the flexible display 410 occurs and the position of the user's grip are on the same side of the electronic device 400 as illustrated at the top 1201 of FIG. 12A, an alarm indication I indicating the extending direction may be displayed on the screen of the flexible display 410. In the drawings, the edge of the extending side of the display area is shown in the dark contrast, but the disclosure is not limited thereto. According to various embodiments of the disclosure, the alarm indication I indicating the extending direction may be provided in various forms, such as a color, a line, a certain text indication (e.g., an indication of the phrase “the terminal is extended in the direction it is held”), but the disclosure is not limited to a specific form.

Meanwhile, FIG. 12B illustrates an example 1230 in which, according to an embodiment of the disclosure, after extension of the flexible display 410 is performed in the restricted range (e.g., section a) when the side where extension of the screen area of the flexible display 410 occurs and the position of the user's grip are on the same side of the electronic device 400 as illustrated at the top 1210 of FIG. 12A, additional extension to the remaining restricted range (e.g., section b) occurs when the user changes the grip position to cause the side where extension of the screen area of the flexible display 410 occurs and the position of the user's grip to be on the different sides.

FIGS. 12A and 12B and related descriptions focus primarily on an example where the screen area of the flexible display 410 extends, but the disclosure is not limited thereto. According to an embodiment of the disclosure, the above-described configurations may also be applied where the screen area of the flexible display 410 is shrunk. For example, according to various embodiments of the disclosure, when the screen area of the flexible display 410 is shrunk, if the side where the shrinkage occurs and the position of the user's grip are on the same side of the electronic device 400, the shrinkage of the screen area is restricted to the restricted range (e.g., section b) of the entire range (section a+b) and, according to an embodiment, if the user later changes the grip position to cause the side where shrinkage of the screen area of the flexible display 410 occurs and the position of the user's grip to be on different sides, additional shrinkage to the remaining restricted range (e.g., section a) may be performed.

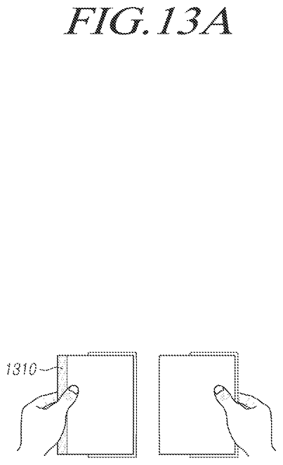

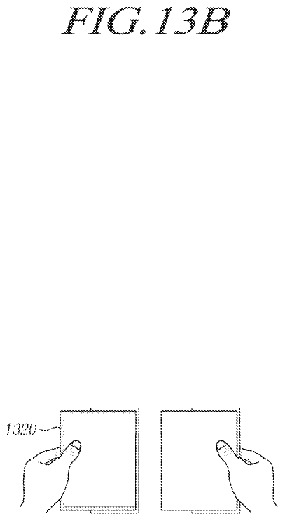

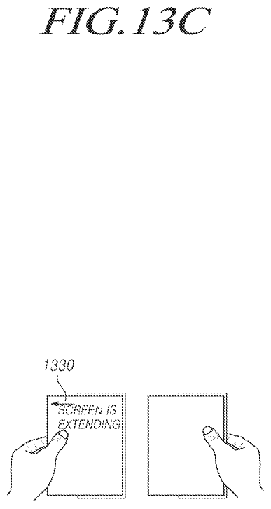

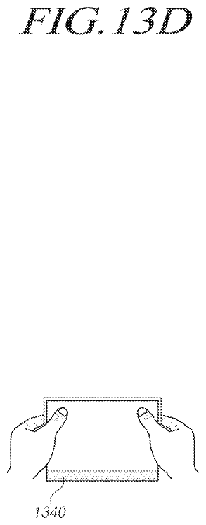

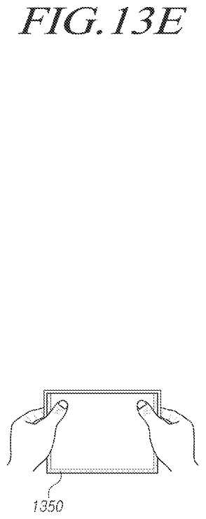

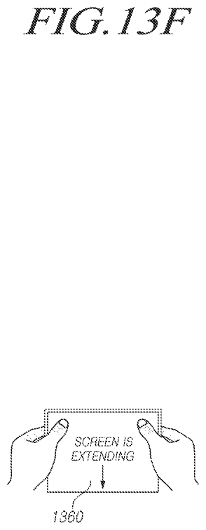

FIGS. 13A, 13B, 13C, 13D, 13E and 13F are diagrams illustrating examples of various graphic indicators or graphic affordances that may be displayed on a flexible display 410 to enhance grip stability when extending or shrinking a screen area of the flexible display 410 according to various embodiments. Such a graphic indicator or graphic affordance may lead the user to respond appropriately (e.g., change the grip position) by allowing the user to recognize that extension or shrinkage of the screen area, which may cause grip instability, is being performed.

For example, when the side where extension of the screen area of the flexible display 410 occurs and the position of the user's grip are on the same side of the electronic device 400, according to an embodiment of the disclosure, as illustrated in FIG. 13A, a graphic indicator 1310 having a color having high visibility (dark contrast in this drawing) may be provided in the corner of the side where extension or shrinkage of the screen area of the flexible display 410 occurs. According to an embodiment of the disclosure, as illustrated in FIG. 13B, a graphic indicator 1320 formed of a line along a U-shaped screen edge to the side in which the screen area of the flexible display 410 is extended or reduced may be provided, or as illustrated in FIG. 13C, an arrow indication and a related text indicator 1330 indicating the direction in which the screen area of the flexible display 410 is extended or reduced may be provided.

Meanwhile, according to an embodiment of the disclosure, when the extension or reduction of the screen area of the flexible display 410 is performed at a lower end of the electronic device 400, as illustrated in FIG. 13D, a graphic indicator 1340 formed of a color having high visibility (dark contrast in this drawing) may be provided in the lower corner where the screen area of the flexible display 410 is extended or reduced. According to an embodiment of the disclosure, as illustrated in FIG. 13E, a graphic indicator 1350 formed of a line along a ␣-shaped screen edge to a lower end in which the screen area of the flexible display 410 is extended or reduced may be provided, or as illustrated in FIG. 13F, an arrow indication and a related text indicator 1360 indicating the direction in which the screen area of the flexible display 410 is extended or reduced may be provided.

According to various embodiments of the disclosure, the driving level determination unit 440 may adjust the driving level for the motor 420 considering the ambient noise context. According to an embodiment of the disclosure, the electronic device 400 may always measure ambient noise through a noise measurement sensor (e.g., Always on Mic), and, as an example, may use the measurement value at a specific time point with respect to the moment when the screen area of the flexible display 410 is to be extended or reduced, or an average or intermediate value of the ambient noise strengths (dB) measured within the last few seconds as ambient noise strength information to adjust the driving level of the motor 420.

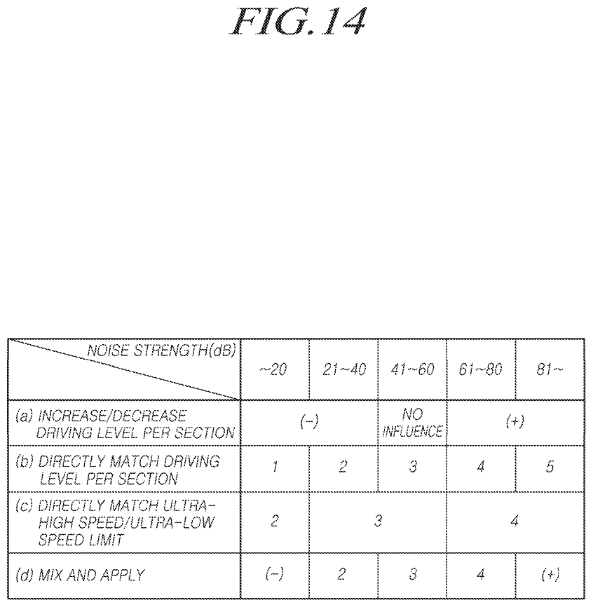

FIG. 14 is a chart illustrating various example methods and criteria for adjusting a driving level for a motor 420 based on ambient noise context by a driving level determination unit 440 under the driving level classifications (e.g., five-step classification) shown in FIG. 5 according to an various embodiments.

For example, (a) of FIG. 14 illustrates a method in which, as described above with reference to (g) of FIG. 6, the driving level determination unit 440 adjusts the driving level of the motor 420 to be increased by one level or decreased by one level according to a predetermined criterion based on the ambient noise context. According to an embodiment of the disclosure, the driving level determination unit 440 may identify the section where the ambient noise strength measured on the electronic device 400 belongs among a plurality of predetermined noise sections, and adjust the driving level to increase by one level or decrease by one level accordingly. As illustrated, in a state of a noise strength larger than a noise strength in a, e.g., 41-60 db range, the driving level determination unit 440 may adjust the driving level of the motor 420 to increase by one step and, in a state of a noise strength smaller than the range, adjust the driving level of the motor 420 to decrease by one step.

Meanwhile, (b) and (c) of FIG. 14 illustrate a method in which the driving level determination unit 440 directly matches the driving level of the motor 420 to a specific level based on the ambient noise context. As illustrated, in the case of (b) of FIG. 14, the driving level of the motor 420 may be matched to step 1, step 2, step 3, step 4, and step 5 (e.g., the example driving level classifications of FIG. 5 may be followed) in the noise strength state of, e.g., 20 db or less, the noise strength state of 21-40 db, the noise strength state of 41-60 db, the noise strength state of 61-80 db, and the noise strength state of 81 db or more, respectively. Meanwhile, as illustrated in (c) of FIG. 14, similarly to (b) of FIG. 14, the driving level determination unit 440 may directly match the driving level of the motor 420 to a specific level, but may match the remaining levels for each condition except for the maximum level (e.g., level 5) and the minimum level (e.g., level 1). According to an embodiment of the disclosure, driving of the motor 420 at the maximum level or the minimum level may be performed by manual setting, but the disclosure is not limited thereto. As illustrated in (c) of FIG. 14, e.g., for the noise strength state of 20 db or less, the noise strength state of 21-60 db, and the noise strength state of 61 db or more, the driving level of the motor 420 may be matched to step 2, step 3, and step 4, respectively.

(d) of FIG. 14 illustrates a mixed method of a method (e.g., (b) and (c) of FIG. 14) of directly matching and determining the driving level of the motor 420 to a specific level according to the noise strength state when determining or adjusting the driving level of the motor 420 according to the ambient noise context and a method (e.g., (a) of FIG. 14) of adjusting to increase or decrease the step of the driving level. According to an embodiment of the disclosure, as illustrated in (d) of FIG. 14, the driving level determination unit 440 may directly match the driving level of the motor 420 to the driving levels of level 2, level 3, and level 4, for the noise strength states of, e.g., 21-40 db, 41-60 db, and 61-80 db, respectively. According to an embodiment of the disclosure, as illustrated in (d) of FIG. 14, the driving level determination unit 440 may adjust the driving level of the motor 420 to be increased or decreased by one step in the noise strength state of, e.g., 20 db or less or 81 db or more.

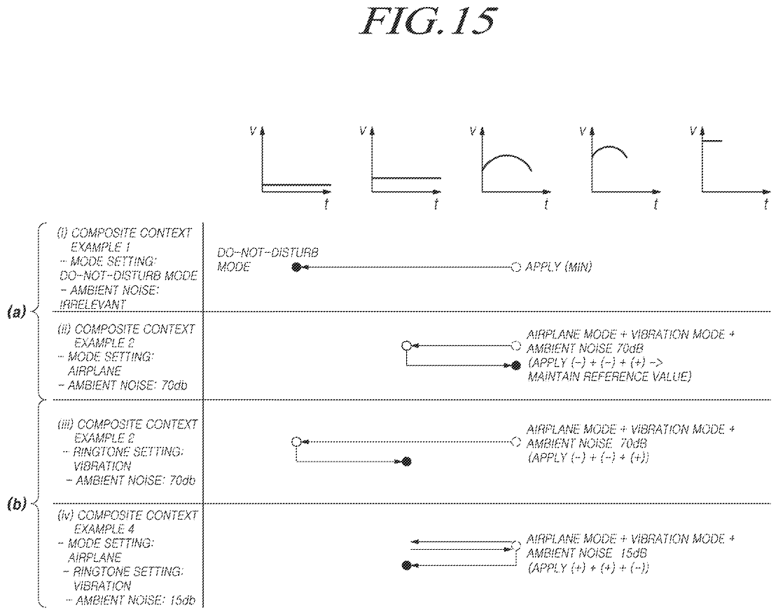

FIG. 15 is a diagram illustrating various examples of adjusting a driving level of a motor 420 based on a driving level adjustment condition of ambient noise context and corresponding adjustment range according to (a) of FIG. 14 and considering the mode setting context and/or ringtone setting context shown in FIG. 6 under the driving level classifications (e.g., five-step classification) shown in FIG. 5 and the procedure flow illustrated in FIG. 7 according to various embodiments.

(a) of FIG. 15 illustrates a situation in which the driving level of a motor is adjusted according to a given condition considering a mode setting context or an ambient noise context. For example, in i) composite context example 1 at the top of (a) of FIG. 15, a do-not-disturb mode is set. In this case, it is schematically illustrated that the driving level of the motor 420 is adjusted from a predetermined reference level (e.g., an intermediate speed/deceleration/acceleration applied level of level 3) to a minimum level (e.g., an ultra-low speed/constant speed level of level 1). In this embodiment, it may be seen that the ambient noise context is not actually considered due to the setting of the do-not-disturb mode.

In ii) composite context example 2 at the bottom of (a) of FIG. 15, an airplane mode is set and the ambient noise strength is 70 dB. In this case, illustrated is a context in which the driving level of the motor 420 is reduced by one step from a predetermined reference level (e.g., an intermediate speed/deceleration/acceleration applied level of level 3, as shown) according to criterion (c) of FIG. 6 by the airplane mode setting, and then increased back by one step according to criterion (a) of FIG. 14 due to the state in which the ambient noise strength is 61 dB or more, thereby maintaining the original reference level.

(b) of FIG. 15 schematically illustrates a situation in which the driving level of a motor is adjusted according to a given condition considering a mode setting context, a ringtone setting context, or an ambient noise context. For example, in iii) composite context example 3 at the top of (b) of FIG. 15, an airplane mode and a vibration mode are set and the ambient noise strength is 70 dB. In this case, illustrated is a context in which the driving level of the motor 420 is reduced twice by one step from a predetermined reference level (e.g., an intermediate speed/deceleration/acceleration applied level of level 3, as shown) according to criteria (c) and (d) of FIG. 6 by the airplane mode setting and vibration mode setting, and then increased by one step according to criterion (a) of FIG. 14 due to the state in which the ambient noise strength is 61 dB or more, thereby adjusting the driving level to the one-step lower level (e.g., a low speed/constant speed level of level 2 as shown) than the original level.

In iv) composite context example 4 at the bottom of (b) of FIG. 15, an airplane mode and a ringtone mode are set and the ambient noise strength is 15 dB. In this case, illustrated is a context in which the driving level of the motor 420 is reduced by one step from a predetermined reference level (e.g., an intermediate speed/deceleration/acceleration applied level of level 3, as shown) according to criterion (c) of FIG. 6 by the airplane mode setting and is then increased by one step according to criterion (d) of FIG. 6 by the ringtone mode setting, and then increased by one step one more time according to criterion (a) of FIG. 14 due to the state in which the ambient noise strength is 61 dB or more, thereby adjusting the driving level to the one-step lower level (e.g., a low speed/constant speed level of level 2 as shown) than the original level. The examples shown in FIG. 15 are merely examples, and the disclosure is not limited to a specific example.

According to various embodiments of the disclosure, the driving level determination unit 440 may determine or adjust the driving level for the motor 420 based on the volume setting context, e.g., volume information about the volume (e.g., a ringtone volume) set on the electronic device 400. According to an embodiment of the disclosure, the volume setting context may be considered, e.g., under the assumption that the ringtone setting context of (d) of FIG. 6 is set to the ringtone mode, but the disclosure is not limited thereto.

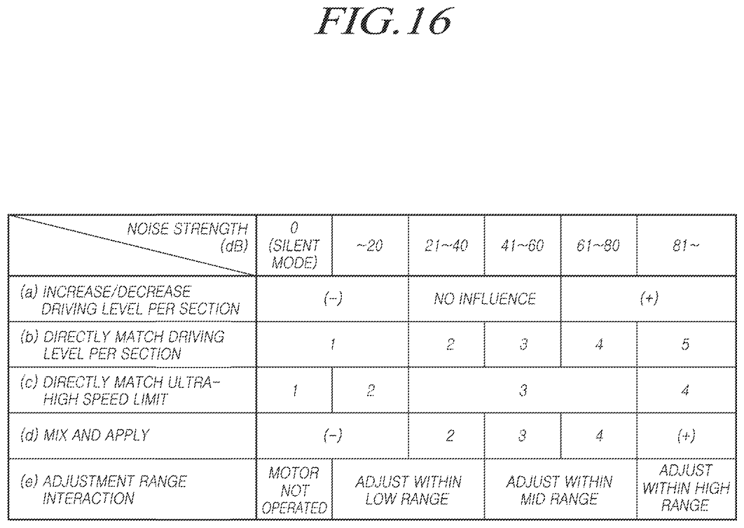

FIG. 16 is a chart illustrating various example methods and criteria for adjusting a driving level for a motor 420 based on volume setting context by a driving level determination unit 440 under the driving level classifications (e.g., five-step classification) shown in FIG. 5 according to various embodiments.

For example, (a) of FIG. 16 illustrates a method in which, as described above with reference to (h) of FIG. 6, the driving level determination unit 440 adjusts the driving level of the motor 420 to be increased by one level or decreased by one level according to a predetermined criterion based on the volume setting context. According to an embodiment of the disclosure, the driving level determination unit 440 may identify the section where the volume set on the electronic device 400 belongs among a plurality of predetermined volume setting sections, and adjust the driving level to increase by one level or decrease by one level accordingly. As illustrated, in a state of a volume setting larger than a volume setting in a, e.g., 21-60% range with respect to the maximum volume, the driving level determination unit 440 may adjust the driving level of the motor 420 to increase by one step and, in a state of a volume setting smaller than the range, adjust the driving level of the motor 420 to decrease by one step.

(b) and (c) of FIG. 16 illustrate a method in which the driving level determination unit 440 directly matches the driving level of the motor 420 to a specific level based on the volume setting context. As illustrated, in the case of (b) of FIG. 16, the driving level of the motor 420 may be matched to step 1, step 2, step 3, step 4, and step 5 (e.g., the example driving level classifications of FIG. 5 may be followed) in the volume setting state of, e.g., 20% or less, the volume setting state of 21-40%, the volume setting state of 41-60%, the volume setting state of 61-80%, and the volume setting state of 81% or more, respectively. Meanwhile, as illustrated in (c) of FIG. 16, similarly to (b) of FIG. 16, the driving level determination unit 440 may directly match the driving level of the motor 420 to a specific level, but may match the remaining levels for each condition except for the maximum level (e.g., level 5). As illustrated in (c) of FIG. 16, e.g., in a 0% volume setting state, e.g., the silent mode, the driving level of the motor 420 may be matched to step 1, and the driving level of the motor 420 may be matched to steps 2, 3, and 4 (e.g., the example driving level classifications of FIG. 5 may be followed) for the volume setting state of 20% or less, the volume setting state of 21-80%, and the volume setting state of 81% or more, respectively.

Further, (d) of FIG. 16 illustrates a mixed method of a method (e.g., (b) and (c) of FIG. 16) of directly matching and determining the driving level of the motor 420 to a specific level according to the volume setting state when determining or adjusting the driving level of the motor 420 according to the volume setting context and a method (e.g., (a) of FIG. 16) of adjusting to increase or decrease the step of the driving level. According to an embodiment of the disclosure, as illustrated in (d) of FIG. 16, the driving level determination unit 440 may directly match the driving level of the motor 420 to, e.g., the driving levels of level 2, level 3, and level 4, for the volume setting state of, e.g., 21-40%, the volume setting state of 41-60, and the volume setting state of 61-80%, respectively. According to an embodiment of the disclosure, as illustrated in (d) of FIG. 16, the driving level determination unit 440 may adjust the driving level of the motor 420 to be increased or decreased by one step in the volume setting state of, e.g., 20% or less or 81% or more.

Meanwhile, according to an embodiment of the disclosure, a predetermined adjustment upper limit may be determined based on the context of the electronic device 400, and the user may manually adjust the driving level of the motor 420 within the adjustment upper limit. According to an embodiment of the disclosure, the upper limit of adjustment for manual adjustment of the motor driving level may be determined, e.g., based on the volume setting state of the electronic device 400. In (e) of FIG. 16, according to the volume setting state, the adjustment upper limit capable of manual adjustment of the driving level of the motor 420 may be matched to one of three predetermined ranges, e.g., a low range, a mid range, and a high range. For example, as illustrated in (e) of FIG. 15, e.g., in a 0% volume setting state, e.g., the silent mode, driving of the motor 420 may be prohibited, and the adjustment range for adjusting the driving level of the motor 420 for each of the volume setting state of 40% or more, the volume setting state of 41-80%, and the volume setting state of 81% or more may be matched to the low range, mid range, and high range, respectively. According to an embodiment of the disclosure, various speed upper limits may be defined for each of the low range, mid range, and high range according to the user or device settings.

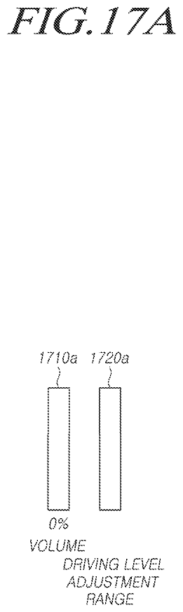

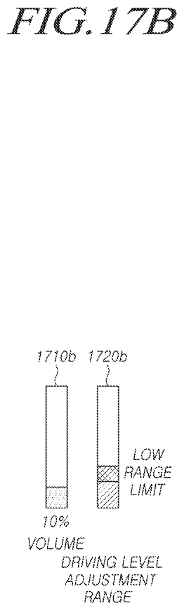

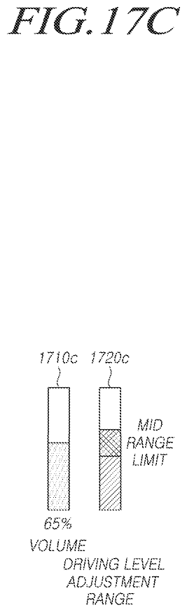

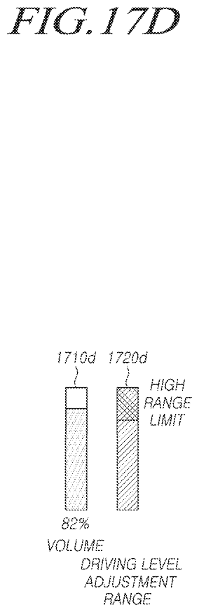

In this regard, FIGS. 17A, 17B, 17C and 17D are diagrams illustrating a relationship between various volume setting states and driving level adjustment ranges in relation to an embodiment of dynamically adjusting a driving level of a motor 420 by a user in an adjustment range determined based on a volume setting state according to (e) of FIG. 16. For example, FIGS. 17A, 17B, 17C and 17D illustrate a par of volume bar indicating the volume setting magnitude and bar indicating the driving level adjustment range, for each of various volume setting states.

FIG. 17A illustrates that the volume bar 1710a is blank when the volume setting state is 0% (silent). FIG. 17A illustrates that the driving level adjustment range bar 1720a is also blank. The state in which the driving level adjustment range bar 1720a is blank indicates that driving of the motor 420 is prohibited.

FIG. 17B illustrates a volume bar 1710b having a portion corresponding to the volume of 10% shown in dark color when the volume is 10%. Further, according to the criterion of (e) of FIG. 16, since the current volume setting corresponds to a section of 40% or less, the driving level adjustment range of the motor may be determined to be the low range. FIG. 17B illustrates a driving level adjustment range bar 1720b in which the driving level of the motor is determined to be within the low adjustment range. As illustrated, the bottom hatched portion of the driving level adjustment range bar 1720b indicates the current driving level state (e.g., the upper limit of the hatched portion indicates the currently set driving level), and the left limit of the gridded portion thereabove indicates the maximum range (the low range in the instant example) to which the driving level adjustment is possible by the user.

FIG. 17C illustrates a volume bar 1710c having a portion corresponding to the volume of 65% shown in dark color when the volume is 65%. Further, according to the criterion of (e) of FIG. 16, since the current volume setting corresponds to a section of 41-80%, the driving level adjustment range of the motor may be determined to be the mid range. FIG. 17C illustrates a driving level adjustment range bar 1720c in which the driving level of the motor is determined to be within the mid adjustment range. As illustrated, the bottom hatched portion of the driving level adjustment range bar 1720c indicates the current driving level state (e.g., the upper limit of the hatched portion indicates the currently set driving level), and the left limit of the gridded portion thereabove indicates the limit of the maximum range (the mid range in the instant example) to which the driving level adjustment is possible by the user.

FIG. 17D illustrates a volume bar 1710d having a portion corresponding to the volume of 82% shown in dark color when the volume is 82%. Further, according to the criterion of (e) of FIG. 16, since the current volume setting corresponds to a section of 81% or more, the driving level adjustment range of the motor may be determined to be the high range. FIG. 17D illustrates a driving level adjustment range bar 1720d in which the driving level of the motor is determined to be within the high adjustment range. As illustrated, the bottom hatched portion of the driving level adjustment range bar 1720d indicates the current driving level state (e.g., the upper limit of the hatched portion indicates the currently set driving level), and the left limit of the gridded portion thereabove indicates the limit of the maximum range (the high range in the instant example) to which the driving level adjustment is possible by the user. According to various embodiments of the disclosure, adjustment of the driving level by the user which is performed within a predetermined adjustment range according to the volume setting state may be performed through, e.g., the volume control bar or other various control means on the electronic device 400, but the disclosure is not limited to a specific example.

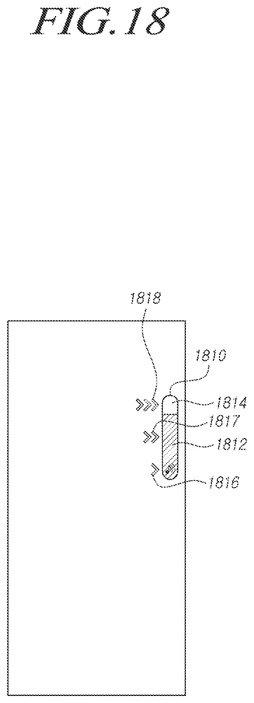

According to an embodiment of the disclosure, the user may control the volume control bar of the electronic device to dynamically change the volume setting state of the electronic device 400 while simultaneously adjusting the driving level of the motor 420 in conjunction therewith. FIG. 18 is a diagram illustrating an example volume control bar that may be displayed on a screen of a display 410 when a volume setting state and a motor (420) driving level are adjusted in conjunction with each other through manipulation of a volume control bar according to various embodiments.

As shown in FIG. 18, the volume control bar 1810 includes a bottom hatched portion 1812 and a top blank portion 1814. The bottom blank portion 1812 shows the current volume setting state and motor driving level. Each arrow indication shown on the left side of the volume control bar 1810 of FIG. 18 is a graphic indication that helps to intuitively understand the motor driving level corresponding to the volume setting section. For example, one arrow 1816 positioned at the bottom left of the volume control bar 1810 of FIG. 18 may indicate a low motor driving level, two arrows 1817 thereabove may indicate an intermediate motor driving level, and three arrows 1818 at the top left may indicate a high motor driving level.

According to an embodiment of the disclosure, the electronic device 400 may provide a visual indication that allows the position where extension or shrinkage of the screen and/or driving level of the motor 420 to be intuitively recognized when the screen of the flexible display 410 is extended or shrunk.

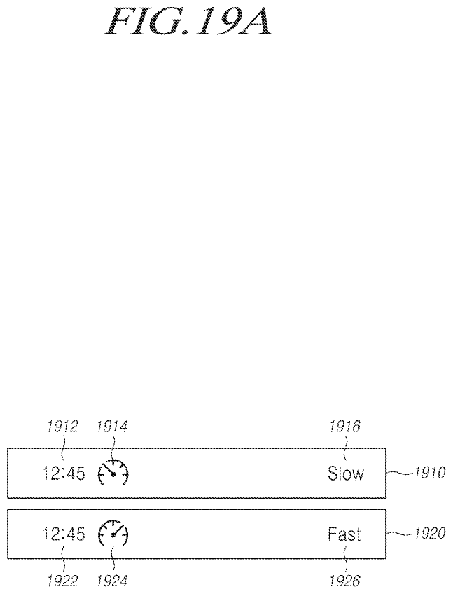

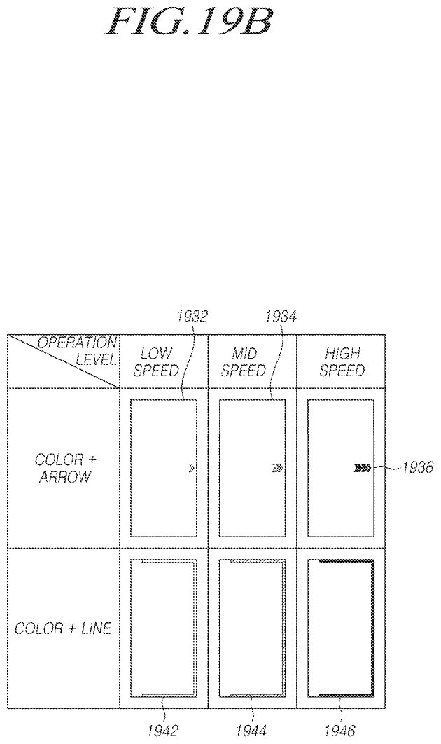

FIG. 19A is a diagram illustrating an example status bar indicating the motor driving level provided through a portion of the flexible display 410, according to various embodiments. According to an embodiment of the disclosure, such a status bar may be displayed in an upper or lower portion of the flexible display 410, but the disclosure is not limited thereto. As shown in FIG. 19A, e.g., the status bar 1910 includes a time indication 1912 on the leftmost side, a speedometer indication 1914 indicating the speed of the driving level of the motor 420 (indicating a low speed), and the corresponding text “Slow” 1916. The status bar 1920 includes a time indication 1922 on the leftmost side, a speedometer indication 1924 indicating the speed of the driving level of the motor 420 (indicating a high speed), and the corresponding text “Fast” 1926. The status bars 1910 and 1920 shown in (a) of FIG. 19 are merely examples, and the disclosure is not limited thereto.

FIG. 19B is a diagram illustrating various example visual indications indicating each driving level and the position where extension or shrinkage occurs, provided on the screen of the flexible display 410 when extension or shrinkage of the screen area of the flexible display 410 occurs, according to various embodiments. According to various embodiments of the disclosure, as shown in FIG. 19B, the position where extension or shrinkage of the screen occurs and each driving level may be shown with arrows in different colors (or contrast) or with lines in different colors (or contrast) surrounding the edge of the screen. For example, the reference numerals 1932, 1934, and 1936 of FIG. 19B indicate that extension of the screen is performed to the right of the electronic device 400 by displaying the arrow toward the right side on the right side of the flexible display 410. According to an embodiment of the disclosure, it is possible to indicate that shrinkage of the screen is performed by displaying an arrow inward of the electronic device 400 on the flexible display 410, and it is possible to indicate that extension or shrinkage of the screen is performed on the left side of the electronic device by displaying an arrow on the left side of the flexible display 410. Further, the reference numerals 1932, 1934, and 1936 of FIG. 19B may display the arrows in different colors and shapes on the flexible display 410 with the driving level of the motor divided into a low speed, mid speed, and high speed. For example, as shown in FIG. 19B, the reference numeral 1932 indicates low-speed extension and shows one arrow (indicated as blank). For example, as shown in FIG. 19B, the reference numerals 1934 and 1936 indicate mid-speed extension and high-speed extension and show two arrows (hatched) and three arrows (darkened), respectively. In this drawing, the arrows indicating the low speed, mid speed, and high speed, respectively, are shown in different contrasts, but the disclosure is not limited thereto. According to various embodiments of the disclosure, each arrow may be shown in a different high-visibility color.

Meanwhile, the reference numerals 1942, 1944, and 1946 of FIG. 19B show that extension or shrinkage of the screen occurs on the right side of the electronic device 400 by displaying a ⊐-shaped line surrounding the outer edge of the flexible display 410 on the right side of the flexible display 410. According to an embodiment of the disclosure, it may be shown that extension or shrinkage of the screen occurs on the left side of the electronic device by displaying a U-shaped line surrounding the left outer edge of the flexible display 410. Further, the reference numerals 1942, 1944, and 1946 of FIG. 19B may display the lines in different colors on the flexible display 410 with the driving level of the motor divided into a low speed, mid speed, and high speed. For example, as shown in FIG. 19B, the reference numeral 1942 indicates low-speed extension or shrinkage, and shows a blank line. For example, as shown in FIG. 19B, the reference numerals 1944 and 1946 indicate mid-speed and high-speed extension or shrinkage, and show a hatched line and a solid black line, respectively. In this drawing, the lines indicating the low speed, mid speed, and high speed, respectively, are shown in different contrasts, but the disclosure is not limited thereto. According to various embodiments of the disclosure, each line may be shown in a different high-visibility color.

Meanwhile, FIG. 19B illustrates a case in which in relation to extension or shrinkage of the screen of the flexible display 410, the current motor driving level and the position where extension or shrinkage of the screen occurs are shown with arrows in different colors (or contrast) and shapes or lines in different colors (or contrast) surrounding the edge of the screen, but the disclosure is not limited thereto. According to various embodiments of the disclosure, in addition to, or instead of, the above-described arrows in various colors (or contrast) and shapes or lines in various colors (or contrast), relevant text information (which may include, e.g., screen extension or shrinkage direction information, driving level information, and/or noise alarm information) may be visually provided.

Further, FIGS. 19A and 19B and the related description focuses primarily on a case where in relation to extension or shrinkage of the screen of the flexible display 410, the current motor driving level and the position where extension or shrinkage of the screen is performed are provided with visual indications, but the disclosure is not limited thereto. According to an embodiment of the disclosure, various visual/audible indications may be provided to indicate the position of the extension or shrinkage of the flexible display 410 and/or the motor driving level.

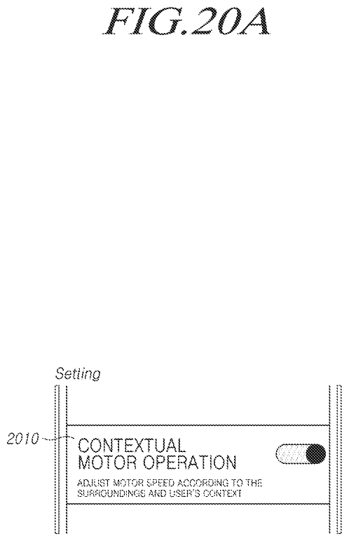

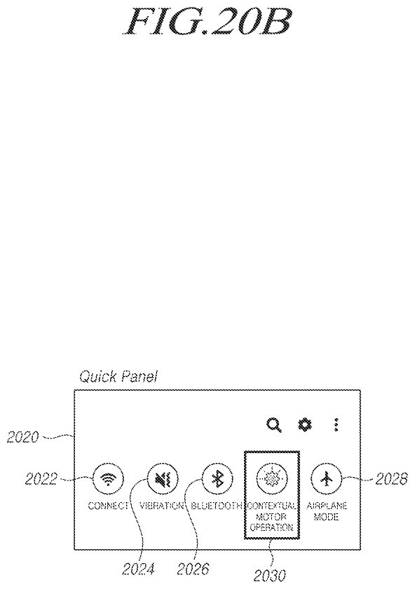

FIGS. 20A and 20B are diagrams illustrating example display of setting options to allow a user to select whether to use a function of adjusting a driving level of a motor 420 based on one or more contexts according to various embodiments.

For example, FIG. 20A illustrates that such an option 2010 is provided in the settings of the electronic device 400, and FIG. 20B illustrates that a motor driving level control option 2030 according to the context is provided along with options for selecting connect 2022, vibration 2024, Bluetooth 2026, and airplane mode 2028. The indications for providing setting options illustrated in FIGS. 20A and 20B are merely examples, and according to various embodiments of the disclosure, other various forms of motor driving level control options according to the context may be provided.

Meanwhile, according to an embodiment of the disclosure, an event for triggering driving of the motor 420 may be generated by pressing a physical button or key provided in the electronic device 400 or touching at a predetermined position on the screen. According to an embodiment of the disclosure, the user may directly determine the driving level for driving the motor or select the default level which is a basis for adjusting the driving level according to the context by adjusting the press on the physical button or key or the touch on the screen at the predetermined position for triggering driving of the motor. For example, according to an embodiment of the disclosure, when the press on the physical button or key is a long press, the driving level or the default level may be determined to be the minimum level among predefined driving levels. For example, according to an embodiment of the disclosure, when the press on the physical button or key is a single press, the driving level or the default level may be determined to be an intermediate level among the predefined driving levels. For example, according to an embodiment of the disclosure, when the press on the physical button or key is a double press, the driving level or the default level may be determined to be the maximum level among predefined driving levels. This configuration is merely an example, and the disclosure is not limited to specific cases.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

An electronic device according to various example embodiments of the disclosure may comprise: a first housing, a second housing configured to slide with respect to the first housing, a motor configured to provide a driving force for sliding the second housing, a flexible display having an externally visible screen area extended or shrunk by driving the motor, a memory storing instructions, and at least one processor, comprising processing circuitry, operably connected to the first housing, the second housing, the flexible display, and the memory. At least one processor may, based on the screen area being requested to be extended or shrunk, be configured to: determine a driving level for the motor based on one or more pieces of context information related to the electronic device and drive the motor according to the determined driving level.

In an example embodiment, the one or more pieces of context information may include at least one of remaining capacity information about a battery of the electronic device, information about whether the screen is extended or shrunk, information about whether a side where the screen is extended or shrunk and a position of a grip on the electronic device being the same side with respect to the electronic device or whether the screen is extended or shrunk to a lower end of the electronic device, information about what application is in an active state, information about which one of an airplane mode, a do-not-disturb mode, and a power saving mode being set, information about which one of a ringtone mode, a vibration mode, and a silent mode is set, information about a strength of noise around the electronic device, information about a volume set on the electronic device, and information about an illuminance around the electronic device.

In an example embodiment, the determined driving level may be a level selected from among a plurality of levels from a minimum level having a minimum speed to a maximum level having a maximum speed, and each of the plurality of levels may be defined by a different time-speed function.

In an example embodiment, at least one processor may be configured to: determine whether corresponding context information meets a specified condition according to priority for the one or more pieces of context information and, based on the condition being met, adjust a step of the driving level according to a determined criterion.

In an example embodiment, at least one processor may be configured to: determine that the driving level is the minimum level among the plurality of levels or adjust the driving level to a level lower than a current level based on the one or more pieces of context information including: i) information indicating that a side where the screen is extended or shrunk and a position of a grip on the electronic device are a same side with respect to the electronic device or that the screen is extended or shrunk to a lower end of the electronic device; ii) information indicating that a do-not-disturb mode or a power saving mode is set on the electronic device; or iii) information indicating that a silent mode is set on the electronic device; or determine that the driving level is the minimum level among the plurality of levels or adjust the driving level to the level lower than the current level based on the one or more pieces of context information being information indicating that an application using a microphone is in an active state; or determine that the driving level is the maximum level among the plurality of levels or adjust the driving level to a level higher than the current level based on the one or more pieces of context information being information indicating that an application using a speaker without using the microphone is in an active state; or adjust the driving level to the level lower than the current level based on the one or more pieces of context information being information indicating that a camera application is in an active state.

In an example embodiment, at least one processor may, based on the one or more pieces of context information including information indicating that a side where the screen is extended or shrunk and a position of a grip on the electronic device are the same side with respect to the electronic device or that the screen is extended or shrunk to a lower end of the electronic device, be configured to: drive the motor at a level lower than the determined driving level for a first time and, after the first time, drive the motor at the determined driving level, or drive the motor so that the extension or shrinkage of the screen is performed only on a partial section smaller than an entire possible section.

In an example embodiment, at least one processor may, based on the one or more pieces of context information include information about a strength of noise around the electronic device, be configured to: determine the driving level by directly matching to one level among the plurality of levels from the ambient noise strength information, or based on the one or more pieces of context information including information about a volume set on the electronic device, determine the driving level by directly matching to one level among the plurality of levels from the volume information.

In an example embodiment, at least one processor may be configured to: determine the driving level based on an input through a volume control bar on the electronic device. The one or more pieces of context information may include a state of a volume set on the electronic device. The input may be performed within a specified range according to the state of the volume.

In an example embodiment, the flexible display may provide at least one of text or a graphic indication indicating at least one of a direction in which the screen is extended or shrunk and the driving level when the screen is extended or shrunk.

In an example embodiment, driving the motor to extend or shrink the screen may be prohibited or restricted based on the electronic device being in a state among a lock state, a do-not-disturb mode set state, a kids lock state, and a silent mode set state.

According to various example embodiments of the disclosure, there may be provided a method for controlling driving of a motor in an electronic device having a flexible display having an externally visible screen extended or shrunk by driving the motor. The method may comprise: obtaining a request for triggering to drive the motor, obtaining one or more pieces of context information related to the electronic device, determining whether corresponding context information meets a condition according to priority for each of the one or more pieces of context information and, based on the condition being determined to be met, adjusting a driving level of the motor, determining a result of the adjustment as the driving level of the motor, and driving the motor according to the determined driving level.

In an example embodiment, the one or more pieces of context information may include at least one of remaining capacity information about a battery of the electronic device, information about whether the screen is extended or shrunk, and information about whether a side where the screen is extended or shrunk and a position of a grip on the electronic device are a same side with respect to the electronic device or whether the screen is extended or shrunk to a lower end of the electronic device.

In an example embodiment, adjusting the driving level of the motor according to a given criteria may include: for each piece of context information, a) determine whether corresponding context information meets a first condition; b) based on the first condition being determined to be met, adjust the driving level to a minimum level having a minimum speed or a maximum level having a maximum speed among a plurality of levels determined from the minimum level to the maximum level; c) based on the first condition being determined to not be met, determine whether the context information meets a second condition; d) based on the second condition being determined to be met, adjust the driving level to at least one step lower level or at least one step higher level among the plurality of levels; and e) based on there being context information next in priority, repeat a) to d) on the context state information next in priority.

In an example embodiment, the context information meeting the first condition may include at least one of, information indicating that a side where the screen is extended or shrunk and a position of a grip on the electronic device are a same side with respect to the electronic device or that the screen is extended or shrunk to a lower end of the electronic device, information indicating that a do-not-disturb mode or a power saving mode is set on the electronic device, information indicating that a silent mode is set on the electronic device, and information indicating that, in the electronic device, an application using a microphone or an application using a speaker without a microphone is in an active state.

In an example embodiment, the driving of the motor may include, base on a side where the screen is extended or shrunk and a position of a grip on the electronic device being a same side with respect to the electronic device or based on the screen being extended or shrunk to a lower end of the electronic device, driving the motor at a level lower than the determined driving level for a first time and, after the first time, driving the motor at the determined driving level, or driving the motor so that the extension or shrinkage of the screen is performed only on a partial section smaller than an entire possible section.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “part” or “module” may include a unit implemented in hardware, software, or firmware, or any combination thereof, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device 100). For example, a processor of the machine (e.g., the electronic device 100) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

Although the disclosure has been illustrated and described with reference to various example embodiments, it will be understood by one of ordinary skill in the art that various changes in form and detail may be made without departing from the spirit and scope of the disclosure including the appended claims and their equivalents. It will also be understood that any of the embodiment(s) described herein may be used in conjunction with any other embodiment(s) described herein.

What is claimed is:

1. An electronic device, comprising:
a first housing;
a second housing configured to slide with respect to the first housing;
a motor configured to provide a driving force for sliding the second housing;
a flexible display having an externally visible screen area configured to be extended or shrunk by driving the motor;
a memory storing instructions; and
at least one processor comprising processing circuitry operably connected to the first housing, the second housing, the flexible display, and the memory,
wherein at least one processor is configured to:
based on the screen area being requested to be extended or shrunk, determine a driving level for the motor based on one or more pieces of context information related to the electronic device; and
drive the motor according to the determined driving level.

2. The electronic device of claim 1, wherein the one or more pieces of context information include remaining capacity information about a battery of the electronic device.

3. The electronic device of claim 1, wherein the one or more pieces of context information include at least one of:
information about whether the screen area is to be extended or to be shrunk; and
information about whether a side where the screen area is to be extended or shrunk and a position of a grip on the electronic device is the same side with respect to the electronic device or about whether the screen area is to be extended or shrunk at a lower end of the electronic device.

4. The electronic device of claim 1, wherein the one or more pieces of context information include at least one of:
information about what application is in an active state;
information about whether one of an airplane mode, a do-not-disturb mode, and a power saving mode is set;
information about whether one of a ringtone mode, a vibration mode, and a silent mode is set;
information about a strength of ambient noise around the electronic device;
information about a volume set on the electronic device; and
information about an illuminance around the electronic device.

5. The electronic device of claim 1, wherein the determined driving level is a level selected from among a plurality of levels from a minimum level having a minimum speed to a maximum level having a maximum speed, and wherein each of the plurality of levels is defined by a different time-speed function.

6. The electronic device of claim 5, wherein at least one processor is configured to, for each of the one or more pieces of context information: determine according to priority whether the respective piece of the context information meets a specified condition and, based on the specified condition being met, adjust the driving level according to a determined criterion.

7. The electronic device of claim 5, wherein at least one processor is configured to
determine the driving level to be the minimum level among the plurality of levels or adjust the driving level to be a level lower than a current level, based on the one or more pieces of context information including:
i) information indicating that a side where the screen area is to be extended or shrunk and a position of a grip on the electronic device are a same side with respect to the electronic device or that the screen area is to be extended or shrunk at a lower end of the electronic device;
ii) information indicating that a do-not-disturb mode or a power saving mode is set on the electronic device; or
iii) information indicating that a silent mode is set on the electronic device.

8. The electronic device of claim 5, wherein at least one processor is configured to:
determine the driving level to be the minimum level among the plurality of levels or adjust the driving level to be the level lower than the current level based on the one or more pieces of the context information including information indicating that an application using a microphone is in an active state; or
determine the driving level to be the maximum level among the plurality of levels or adjust the driving level to be a level higher than the current level based on the one or more pieces of the context information including information indicating that an application using a speaker without using the microphone is in an active state; or
adjust the driving level to be the level lower than the current level based on the one or more pieces of the context information include information indicating that a camera application is in an active state.

9. The electronic device of claim 5, wherein at least one processor is configured to:
based on the one or more pieces of the context information including information indicating that a side where the screen area is to be extended or shrunk and a position of a grip on the electronic device is the same side with respect to the electronic device or information indicating that the screen area is to be extended or shrunk at a lower end of the electronic device,
drive the motor at a level lower than the determined driving level for a first time period and, based on the first time period, drive the motor at the determined driving level, or
drive the motor so that the extension or shrinkage of the screen area occurs on a partial section smaller than an entire possible section.

10. The electronic device of claim 1, wherein at least one processor is configured to:
based on the one or more pieces of context information including information about a strength of ambient noise around the electronic device, determine the driving level by directly matching to one level among the plurality of levels from the strength of ambient noise.

11. The electronic device of claim 1, wherein at least one processor is configured to:
based on the one or more pieces of context information including information about a volume set on the electronic device, determine the driving level by directly matching to one level among the plurality of levels from the volume.

12. The electronic device of claim 1, wherein at least one processor is configured to:
determine the driving level based on an input through a volume control bar on the electronic device,
wherein the one or more pieces of the context information includes a state of a volume set on the electronic device, and wherein the input is performed within a determined range according to the state of the volume.

13. The electronic device of claim 1, wherein the flexible display is configured to provide, based on the screen area being extended or shrunk, at least one of text or a graphic indication indicating at least one of a direction in which the screen area is extended or shrunk or the driving level.

14. The electronic device of claim 1, wherein driving the motor to extend or shrink the screen area is prohibited or restricted based on the electronic device being in one state among a lock state, a do-not-disturb mode set state, a kids lock state, and a silent mode set state.

15. A method for controlling driving of a motor in an electronic device having a flexible display having an externally visible screen area extended or shrunk by driving the motor, the method comprising:
obtaining a request for triggering to drive the motor;
obtaining one or more pieces of context information related to the electronic device;
for each of the one or more pieces of the context information, determine according to priority whether the respective piece of the context information meets a condition and, based on the condition being met, adjust a driving level of the motor according to a given criterion;
determine a result of the adjustment as the driving level of the motor; and
drive the motor according to the determined driving level.

16. The method of claim 15, wherein the one or more pieces of the context information include remaining capacity information of a battery of the electronic device.

17. The method of claim 15, wherein the one or more pieces of the context information include at least one of:
information about whether the screen area is to be extended or to be shrunk; and
information about whether a side where the screen area is to extended or shrunk and a position of a grip on the electronic device is the same side with respect to the electronic device or about whether the screen area is to be extended or shrunk at a lower end of the electronic device.

18. The method of claim 15, wherein the adjusting the driving level of the motor according to a given criterion includes:
for each piece of context information:
a) determine whether the respective piece of the context information meets a first condition;
b) based on the first condition being determined to be met, adjust the driving level to a minimum level having a minimum speed or a maximum level having a maximum speed among a plurality of levels from the minimum level to the maximum level;
c) based on the first condition being determined not to be met, determine whether the context information meets a second condition;
d) based on the second condition being determined to be met, adjust the driving level to at least one lower level or at least one higher level among the plurality of levels; and
e) based on a next piece of the context information in priority remaining, repeat a) to d) on a next piece of the context information in priority.

19. The method of claim 18, wherein the piece of the context information meeting the first condition includes at least one of:
information indicating that a side where the screen area is to be extended or shrunk and a position of a grip on the electronic device is the same side with respect to the electronic device or that the screen area is to be extended or shrunk at a lower end of the electronic device;
information indicating that a do-not-disturb mode or a power saving mode is set on the electronic device;
information indicating that a silent mode is set on the electronic device; and
information indicating that, in the electronic device, an application using a microphone or an application using a speaker without a microphone is in an active state.

20. The method of claim 15, wherein the driving of the motor includes:
based on a side where the screen area is to be extended or shrunk and a position of a grip on the electronic device is the same side with respect to the electronic device or based on the screen area being extended or shrunk at a lower end of the electronic device,
driving the motor at a level lower than the determined driving level for a first time period and, based on the first time period, driving the motor at the determined driving level, or
driving the motor so that the extension or shrinkage of the screen area occurs on a partial section smaller than an entire possible section.
